(19) United States
(12) Patent Application Publication
(10) Pub. No.: US 2026/0332866 A1
(43) Pub. Date: Oct. 22, 2026

(54) TILT MECHANISM AND IMAGING APPARATUS

(71) Applicant: FUJIFILM Corporation, Tokyo (JP)

(72) Inventor: Takayuki SHIMIZU, Saitama (JP)

(73) Assignee: FUJIFILM Corporation, Tokyo (JP)

(21) Appl. No.: 19/698,834

(22) Filed: Jun. 4, 2026

Related U.S. Application Data
(63) Continuation of application No. PCT/JP2024/041575, filed on Nov. 25, 2024.

(30) Foreign Application Priority Data
Dec. 25, 2023 (JP) 2023-218070

(51) Int. Cl. H04N 23/53

(52) U.S. Cl. CPC H04N 23/531

(57) ABSTRACT

A tilt mechanism of an imaging apparatus including a first component including an imaging unit, a second component, and a third component including a monitor unit, includes: a first hinge that rotatably connects the first component and the second component around a first axis; and a second hinge that rotatably connects the second component and the third component around a second axis; the first component includes a first attachment portion to which an accessory device is attachable, and the first hinge includes a recessed portion that exposes the first attachment portion on a side in a predetermined direction in a case where a rotational state of the first hinge is a first state.

### CROSS REFERENCE TO RELATED APPLICATION

This is a continuation of International Application No. PCT/JP2024/041575 filed on Nov. 25, 2024, and claims priority from Japanese Patent Application No. 2023-218070 filed on Dec. 25, 2023, the entire disclosures of which are incorporated herein by reference.

### BACKGROUND OF THE INVENTION

### 1. Field of the Invention

The present invention relates to a tilt mechanism and an imaging apparatus.

### 2. Description of the Related Art

JP2015-088945A discloses an electronic apparatus comprising a main body, a liquid crystal monitor, a first hinge shaft, a second hinge shaft, and a slide plate, in which the slide plate is rotatably supported around an axis along one side of an upper portion of a rear surface of the main body by the first hinge shaft, and the liquid crystal monitor is rotatably supported around an axis orthogonal to the first hinge shaft by the second hinge shaft.

JP2023-114934A discloses an imaging apparatus comprising a camera body and a display unit, in which the display unit is connected to the camera body via a vertical tilt mechanism unit and a horizontal vari-angle mechanism unit, the vertical tilt mechanism unit comprises a first support plate and a second support plate in this order, a lower end edge of the first support plate is rotatably supported on a rear surface of the camera body via a first tilt shaft, and an upper end edge is rotatably supported by the second support plate via a second tilt shaft, the horizontal vari-angle mechanism unit has two degrees of freedom of an opening/closing axis and a rotation axis with respect to the second support plate, and various dispositions of the display unit are enabled by rotation of four axes (the first tilt shaft, the second tilt shaft, the opening/closing axis, and the rotation axis).

JP2020-177068A discloses an electronic apparatus in which a display unit is tilt-operated in four different directions (right, left, down, and up) with respect to a housing by an opening/closing mechanism having four rotation axes (first to fourth axes), and the display unit and a signal processing substrate mounted in the housing are electrically connected to each other by a flexible substrate.

JP2019-102958A discloses an electronic apparatus including a camera body and a vari-angle unit including a liquid crystal display panel, in which a hinge portion that rotatably supports the vari-angle unit around two axes (a first rotational axis and a second rotational axis orthogonal to the first rotational axis) is provided at one end of an exterior cover covering the camera body in a horizontal direction, the vari-angle unit includes a geomagnetic sensor and an acceleration sensor, the geomagnetic sensor detects an azimuth in which a display surface of the vari-angle unit faces a geomagnetic field, and the acceleration sensor detects accelerations in two (or three) axis directions that act on the vari-angle unit and are orthogonal to each other.

### SUMMARY OF THE INVENTION

One embodiment according to the technology of the present disclosure provides a tilt mechanism and an imaging apparatus that can enable a flexible imaging form while suppressing a decrease in degree of freedom of attachment of an accessory device.
(1)

A tilt mechanism of an imaging apparatus, the imaging apparatus including a first component including an imaging unit, a second component, and a third component including a monitor unit, the tilt mechanism comprising:
a first hinge that rotatably connects the first component and the second component around a first axis; and
a second hinge that rotatably connects the second component and the third component around a second axis;
in which the first component includes a first attachment portion to which an accessory device is attachable, and
the first hinge includes a recessed portion that exposes the first attachment portion on a side in a predetermined direction in a case where a rotational state of the first hinge is a first state.
(2)

The tilt mechanism according to (1),
in which the first attachment portion is provided on a side in a first direction of a portion of the first component where the first hinge is provided, and the accessory device is attachable by insertion from a second direction opposite to the first direction, and
the predetermined direction is the second direction.
(3)

The tilt mechanism according to (1) or (2),
in which at least a part of the first attachment portion is disposed so as to extend into the first component, and
in the first state,
the first attachment portion is
   only partially visible as viewed from a first direction of the first component, and
   entirely visible as viewed from a second direction opposite to the first direction.
(4)

The tilt mechanism according to any one of (1) to (3),
in which the first state is a rotational state of the first hinge in which the second component is closed with respect to the first component.
(5)

The tilt mechanism according to any one of (1) to (4),
in which the imaging apparatus further includes a fourth component,
the tilt mechanism further comprises a third hinge that rotatably connects the second component and the fourth component around a third axis, and
the second hinge rotatably connects the fourth component and the third component around the second axis.
(6)

The tilt mechanism according to any one of (1) to (5),
in which the first component includes a second attachment portion to which the accessory device is attachable in an attachment direction different from an attachment direction of the first attachment portion, at a position different from a position of the first attachment portion.
(7)

The tilt mechanism according to any one of (1) to (6),
in which the imaging apparatus includes a flexible electronic substrate that electrically connects the first component and the third component.
(8)

An imaging apparatus including the tilt mechanism according to any one of (1) to (7),
in which the third component includes a first acceleration sensor, a first proximity sensor that detects proximity to the first component, and a second proximity sensor that detects proximity to the second component, and
the imaging apparatus comprises a control unit that performs control of display on the monitor unit, based on detection results of the first acceleration sensor, the first proximity sensor, and the second proximity sensor.
(9)

The imaging apparatus according to (8),
in which a predetermined device is attachable in a case where the rotational state of the first hinge is a second state,
the imaging apparatus further comprises an attachment sensor that detects presence or absence of attachment of the predetermined device, and
the control unit performs the control of the display based on detection results of the first acceleration sensor, the first proximity sensor, the second proximity sensor, and the attachment sensor.
(10)

The imaging apparatus according to (9),
in which the second state is a rotational state of the first hinge in which the second component is opened with respect to the first component.
(11)

The imaging apparatus according to (9) or (10),
in which the first component includes a second acceleration sensor, and
the control unit performs the control of the display based on detection results of the first acceleration sensor, the first proximity sensor, the second proximity sensor, the attachment sensor, and the second acceleration sensor.
(12)

The imaging apparatus according to any one of (8) to (10),
in which the first proximity sensor detects proximity of the first component in a third direction of the third component,
the second proximity sensor detects proximity of the second component in the third direction of the third component, and
in a case where the third component is divided into a first region and a second region by a straight line passing through a center portion of the third component as viewed from the third direction, the first proximity sensor is provided in the first region, and the second proximity sensor is provided in the second region.
(13)

The imaging apparatus including the tilt mechanism according to any one of (1) to (7),
in which a cooling device that cools the first component is attachable to the first component in a case where the rotational state of the first hinge is a second state.
(14)

A tilt mechanism of an imaging apparatus, the imaging apparatus including a first component including an imaging unit, a second component, and a third component including a monitor unit, the tilt mechanism comprising:
a first hinge that rotatably connects the first component and the second component around a first axis; and
a second hinge that rotatably connects the second component and the third component around a second axis;
in which the first component includes a first attachment portion to which an accessory device is attachable,
the accessory device is attachable to the first attachment portion in a case where a rotational state of the first hinge is a state in which the second component is closed with respect to the first component, and
attachment of the accessory device to the first attachment portion is suppressed in a case where the rotational state of the first hinge is a state in which the second component is opened with respect to the first component.

According to the present invention, it is possible to provide a tilt mechanism and an imaging apparatus that can enable a flexible imaging form while suppressing a decrease in degree of freedom of attachment of an accessory device.

### BRIEF DESCRIPTION OF THE DRAWINGS

FIG. 1 is a front perspective view simply showing an example of an imaging apparatus 1 according to the present embodiment.

FIG. 2 is a rear perspective view of the imaging apparatus 1 shown in FIG. 1.

FIG. 3 is a front perspective view showing an example of a state in which a display 6 of the imaging apparatus 1 is opened with respect to a plate 4.

FIG. 4 is a rear perspective view of the imaging apparatus 1 shown in FIG. 3.

FIG. 5 is a front perspective view showing an example of a state in which the plate 4 of the imaging apparatus 1 is opened with respect to an imaging apparatus main body 2.

FIG. 6 is a rear perspective view of the imaging apparatus 1 shown in FIG. 5.

FIG. 7 is a front perspective view showing an example of a state in which the plate 4 of the imaging apparatus 1 is opened with respect to the imaging apparatus main body 2 and the display 6 is further opened with respect to the plate 4.

FIG. 8 is a rear perspective view of the imaging apparatus 1 shown in FIG. 7.

FIG. 9 is a front perspective view showing an example of the imaging apparatus 1 in which a cooling device 8 is attached to a rear surface 24 of the imaging apparatus main body 2.

FIG. 10 is a rear perspective view of the imaging apparatus 1 shown in FIG. 9.

FIG. 11 is a diagram showing an example of a hardware configuration of the imaging apparatus main body 2.

FIG. 12 is a diagram showing an example of connection between the imaging apparatus main body 2 and the display 6.

FIG. 13 is a diagram showing a first form of vertical shooting in the imaging apparatus 1.

FIG. 14 is a diagram showing a second form of the vertical shooting in the imaging apparatus 1.

FIG. 15 is a diagram showing a third form of the vertical shooting in the imaging apparatus 1.

FIG. 16 is a diagram showing a fourth form of the vertical shooting in the imaging apparatus 1.

FIG. 17 is a diagram showing a fifth form of the vertical shooting in the imaging apparatus 1.

FIG. 18 is a diagram showing a first form of horizontal shooting in the imaging apparatus 1.

FIG. 19 is a diagram showing a second form of the horizontal shooting in the imaging apparatus 1.

FIG. 20 is a diagram showing a third form of the horizontal shooting in the imaging apparatus 1.

FIG. 21 is a diagram showing a fourth form of the horizontal shooting in the imaging apparatus 1.

FIG. 22 is a diagram showing a fifth form of the horizontal shooting in the imaging apparatus 1.

FIG. 23 is a diagram showing a sixth form of the horizontal shooting in the imaging apparatus 1.

FIG. 24 is a diagram showing a first form of disposition of a main body proximity sensor 63 and a plate proximity sensor 64.

FIG. 25 is a diagram showing a second form of the disposition of the main body proximity sensor 63 and the plate proximity sensor 64.

FIG. 26 is a diagram showing a modification example of the tilt mechanism.

FIG. 27 is a diagram showing an example of a horizontal shooting form in the imaging apparatus 1 having a modification tilt function.

### DESCRIPTION OF THE PREFERRED EMBODIMENTS

Hereinafter, an example of an embodiment of the present invention will be described with reference to the drawings. In the present embodiment, the terms “upward direction”, “downward direction”, “leftward direction”, “rightward direction”, “forward direction”, and “rearward direction” are used, but these directions are relative directions set for convenience of description for the imaging apparatus shown in each drawing.

### Imaging Apparatus of Embodiment

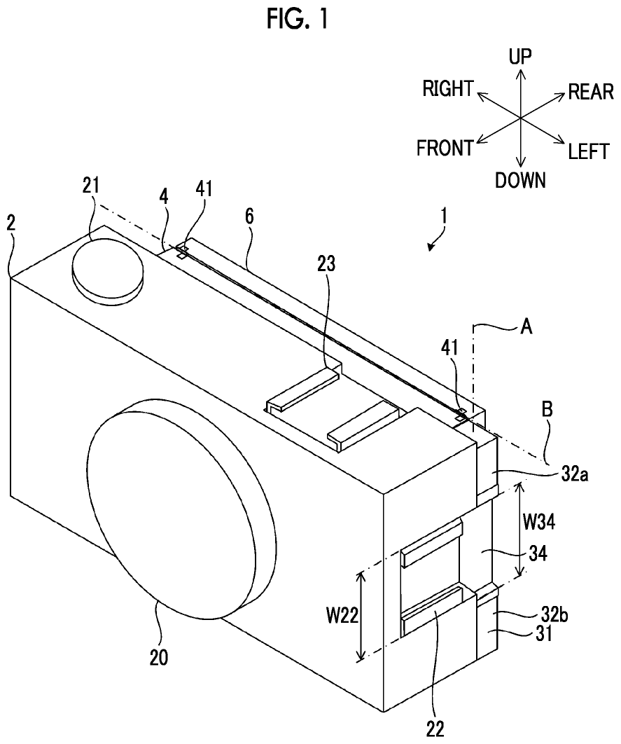

FIG. 1 is a front perspective view simply showing an example of an imaging apparatus 1 according to the present embodiment. As shown in FIG. 1, examples of the imaging apparatus include a digital camera or a single-lens reflex camera capable of imaging a motion picture. The imaging apparatus 1 comprises an imaging apparatus main body 2 that is an example of a “first component”, a plate 4 that is an example of a “second component”, and a display 6 that is an example of a “third component”, according to the embodiment of the present invention.

The imaging apparatus main body 2 is formed in a substantially rectangular shape as viewed from the front (front side of the imaging apparatus 1), and has a horizontally long rectangular shape in which an upper side and a lower side are long sides and a left side and a right side are short sides among four sides. The imaging apparatus main body 2 is provided with a lens 20 that constitutes a part of an imaging unit at a front portion of the imaging apparatus main body 2. In addition, the imaging apparatus main body 2 is provided with an imaging element (not shown) that constitutes a part of the imaging unit inside the imaging apparatus main body 2. In addition, the imaging apparatus main body 2 is provided with a release button 21 at a right portion of an upper surface.

In addition, the imaging apparatus main body 2 is provided with a first accessory shoe 22 that is an example of a “first attachment portion” of the present invention at a left side portion of the imaging apparatus main body 2, and is provided with a second accessory shoe 23 that is an example of a “second attachment portion” according to the embodiment of the present invention at an upper portion. The first accessory shoe 22 is an accessory shoe provided on a short side of the imaging apparatus main body 2. The second accessory shoe 23 is an accessory shoe provided on a long side of the imaging apparatus main body 2. The first accessory shoe 22 and the second accessory shoe 23 are attachment portions to which accessory devices such as a microphone, a strobe, and an external finder can be mounted. The first accessory shoe 22 and the second accessory shoe 23 may be a hot shoe or a cold shoe.

In addition, the imaging apparatus main body 2 is provided with a first hinge 31 at a left side of a rear portion of the imaging apparatus main body 2. The first hinge 31 has a first axis A extending along a short side of the left side of the imaging apparatus main body 2. The first hinge 31 is provided adjacent to the first accessory shoe 22 at a position behind a position where the first accessory shoe 22 is provided.

The plate 4 is attached to a rear side of the imaging apparatus main body 2. The plate 4 is rotatably connected to the imaging apparatus main body 2 by the first hinge 31 around the first axis A.

The display 6 is attached to the rear side of the imaging apparatus main body 2 together with the plate 4. The display 6 is provided with a second hinge 41 at an upper portion of the display 6. The display 6 is connected to the plate 4 via the second hinge 41. The second hinge 41 has a second axis B extending along a long side of an upper side of the imaging apparatus main body 2. A direction in which the second axis B extends is a direction orthogonal to a direction in which the first axis A extends. The display 6 is rotatably connected to the plate 4 by the second hinge 41 around the second axis B. The fact that the first axis A and the second axis B “extend along” the sides of the imaging apparatus main body 2 means that the first axis A and the second axis B are parallel to the sides without being separated from the sides of the imaging apparatus main body 2.

As described above, the imaging apparatus 1 according to the present embodiment comprises the tilt mechanism including the first hinge 31 that rotatably connects the imaging apparatus main body 2 and the plate 4 around the first axis A and the second hinge 41 that rotatably connects the plate 4 and the display 6 around the second axis B.

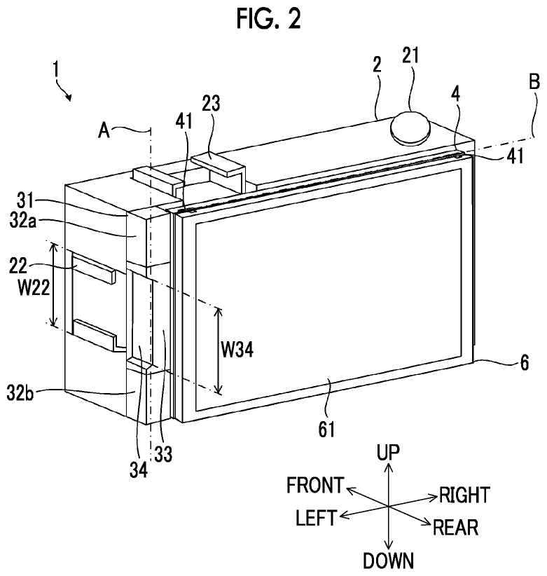

FIG. 2 is a rear perspective view of the imaging apparatus 1 shown in FIG. 1. As shown in FIG. 2, the display 6 includes a monitor unit 61. The display 6 has a substantially flat plate shape and is formed in a substantially rectangular shape in a case of viewing the monitor unit 61 from a front surface. The display 6 can function as a rear surface monitor of the imaging apparatus 1. A captured image of an imaging target, an operation panel, or the like is appropriately displayed on the monitor unit 61 of the display 6. The plate 4 is disposed on a front side of the display 6. The plate 4 has a substantially flat plate shape and is formed in a substantially rectangular shape, similarly to the display 6. The plate 4 and the display 6 are disposed along a rear surface of the imaging apparatus main body 2 in a state of being superimposed on each other, with the plate 4 on a side close to the imaging apparatus main body 2 and the display 6 on a side far from the imaging apparatus main body 2.

As described above, the display 6 is rotatable around a second axis B with respect to the plate 4 by the second hinge 41, and the display 6 shown in FIG. 2 is in a state of being closed with respect to the plate 4. The closed state is a state in which a portion of the display 6 other than a portion where the second hinge 41 is provided is closest to the plate 4. In addition, as described above, the plate 4 is rotatable around a first axis A with respect to the imaging apparatus main body 2 by the first hinge 31, and the plate 4 shown in FIG. 2 is in a state of being closed with respect to the imaging apparatus main body 2. The closed state is a state in which a portion of the plate 4 other than a portion where the first hinge 31 is provided is closest to the imaging apparatus main body 2. The state in which the plate 4 is closed with respect to the imaging apparatus main body 2 is a “first state” of the first hinge 31.

The first accessory shoe 22 is provided in a forward direction of the first hinge 31 at a left rear end portion of the imaging apparatus main body 2 where the first hinge 31 is provided, for example, on a left side portion of the imaging apparatus main body 2. At least a part of the first accessory shoe 22 is provided so as to extend (to be embedded) into the left side portion of the imaging apparatus main body 2. Therefore, in the first accessory shoe 22, a height of a portion of the first accessory shoe 22 exposed to the left of a left side surface of the imaging apparatus main body 2 is, for example, lower than a height of a portion of the second accessory shoe 23 provided on an upper portion of the imaging apparatus main body 2, which is exposed above an upper surface of the imaging apparatus main body 2. The first accessory shoe 22 is configured to attach an accessory device by being inserted from a rearward direction (rear surface side) of the imaging apparatus main body 2. The forward direction of the imaging apparatus main body 2 is an example of a “first direction” according to the embodiment of the present invention. The rearward direction of the imaging apparatus main body 2 is an example of a “second direction” according to the embodiment of the present invention.

The second accessory shoe 23 is provided at a position (upper portion of the imaging apparatus main body 2) different from the first accessory shoe 22. The second accessory shoe 23 is configured to attach an accessory device in an attachment direction different from the first accessory shoe 22. The “attachment direction” referred to here is, for example, an attachment direction that is an appropriate orientation in a case of vertical shooting of the imaging apparatus 1 in a case of the first accessory shoe 22. In addition, the attachment direction in a case of the second accessory shoe 23 is an attachment direction that is an appropriate orientation in a case of horizontal shooting of the imaging apparatus 1. The appropriate orientation is an orientation in which two microphones are arranged on the left and right in a case where a stereo microphone is attached to the first accessory shoe 22 or the second accessory shoe 23. The stereo microphone attached to the first accessory shoe 22 in a case where the imaging apparatus 1 is set in the orientation for vertical shooting and the stereo microphone attached to the second accessory shoe 23 in a case where the imaging apparatus 1 is set in the orientation for horizontal shooting are each attached to an upper side of the imaging apparatus main body 2.

The first hinge 31 includes a first fixing part 32a provided on an upper side of the imaging apparatus main body 2, a second fixing part 32b provided on a lower side, and a rotating portion 33 provided between the first fixing part 32a and the second fixing part 32b.

The first fixing part 32a and the second fixing part 32b are fixed to the imaging apparatus main body 2. The rotating portion 33 is rotatably held about a first axis A with respect to the first fixing part 32a and the second fixing part 32b. In addition, the rotating portion 33 supports the plate 4. Therefore, the rotating portion 33 is rotatable around the first axis A with respect to the imaging apparatus main body 2 together with the plate 4.

The first hinge 31 includes a recessed portion 34 in the rotating portion 33. The recessed portion 34 is formed on a left side portion of the rotating portion 33. The recessed portion 34 is formed to have a width W34 larger than a width W22 (width in the up-down direction) of the first accessory shoe 22 provided in front of the first hinge 31. Therefore, in a case where the rotational state of the first hinge 31 is a state where the plate 4 is closed with respect to the imaging apparatus main body 2 as shown in FIGS. 1 and 2, the first accessory shoe 22 on the front side of the first hinge 31 is exposed on a side of the imaging apparatus main body 2 in the rearward direction via the recessed portion 34 of the first hinge 31 in a case where the imaging apparatus 1 is viewed from the rear side. That is, in a case where the imaging apparatus 1 is viewed from the rear side in this state, all of the first accessory shoe 22 (all including a portion that is inserted into the imaging apparatus main body 2) is visible via the recessed portion 34 of the first hinge 31. In a case where the plate 4 is closed with respect to the imaging apparatus main body 2 and the recessed portion 34 is exposed, the accessory device can be inserted into the first accessory shoe 22 from the rearward direction of the imaging apparatus main body 2. The rear side (second direction) of the imaging apparatus main body 2 is an example of a “predetermined direction” according to the embodiment of the present invention. On the other hand, in a case where the imaging apparatus 1 is viewed from the front side, a portion of the first accessory shoe 22 that is exposed to the left of the left side surface of the imaging apparatus main body 2 is visible, but a portion that is inserted into the imaging apparatus main body 2 is not visible.

The second hinge 41 is provided as a pair of second hinges 41 at both end portions of the plate 4 and the display 6 on the second axis B. The second hinge 41 directly connects the plate 4 and the display 6 to each other at both end portions on the second axis B.

In the following description, regarding the rotational state indicating the opening and closing of the plate 4 and the display 6, as shown in FIGS. 1 and 2, a state where the plate 4 is closed with respect to the imaging apparatus main body 2 and the display 6 is closed with respect to the plate 4 is set as a reference state of the rotational state. In the reference state, the monitor unit 61 of the display 6 is exposed on the rear surface side of the imaging apparatus 1. Therefore, the user can directly visually recognize the display information of the monitor unit 61 on the rear surface side of the imaging apparatus main body 2, for example, while gripping the imaging apparatus main body 2 of the imaging apparatus 1 with the hand. In the reference state, the opening/closing angle of the first hinge 31 on the first axis A is defined as 0°, and the opening/closing angle of the second hinge 41 on the second axis B is defined as 0°. In addition, in the present embodiment, the upper limit value of the opening/closing angle of the first hinge 31 and the second hinge 41 is set to 180°. In addition, the structures of the first hinge 31 and the second hinge 41 described above are merely examples, and the present invention is not limited thereto. Various hinges can be used as long as the first hinge 31 and the second hinge 41 are rotatable around each axis.

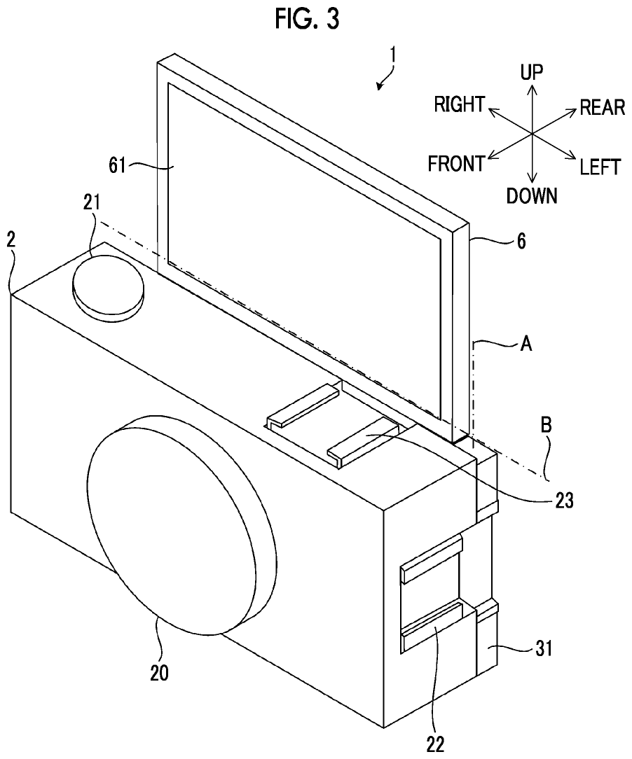

FIG. 3 is a front perspective view showing an example of a state in which the display 6 of the imaging apparatus 1 is opened with respect to the plate 4. In the imaging apparatus 1 shown in FIG. 3, the plate 4 is in a closed state with respect to the imaging apparatus main body 2, and the display 6 is in a completely open state with respect to the plate 4. That is, the imaging apparatus 1 shown in FIG. 3 is in a state where only the display 6 is rotated around the second axis B to the maximum extent with respect to the plate 4 from the reference state shown in FIGS. 1 and 2. In this rotational state, the opening/closing angle of the first hinge 31 on the first axis A is 0°, and the opening/closing angle of the second hinge 41 on the second axis B is 180°.

In a case where the rotational state of the display 6 transitions to a state of being opened by 180° from the reference state, the monitor unit 61 of the display 6 is disposed to face the front side at a position above the imaging apparatus main body 2. Therefore, the user can directly visually recognize the display information of the monitor unit 61 on the front surface side of the imaging apparatus main body 2 while, for example, gripping the imaging apparatus main body 2 of the imaging apparatus 1 with the hand. The display of the monitor unit 61 on the display 6 in this case is a so-called vertically inverted display, and is configured to be suitable for the user to take a self-portrait.

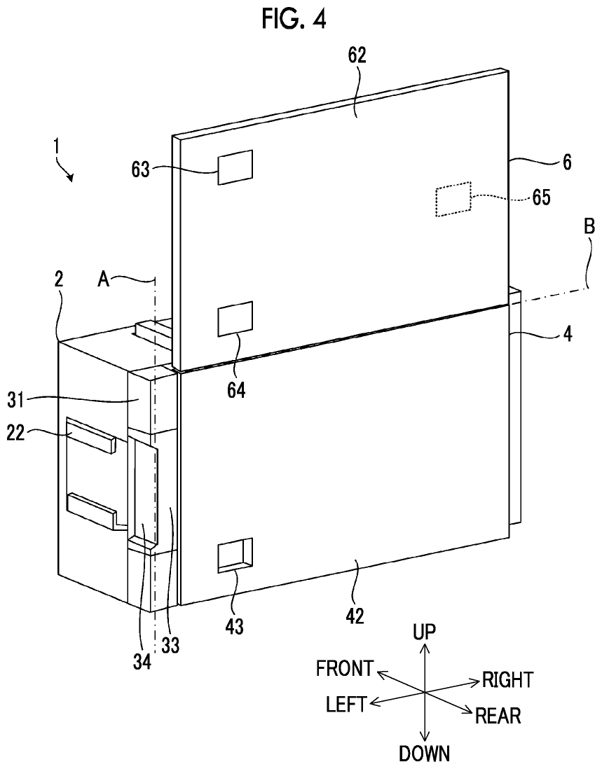

FIG. 4 is a rear perspective view of the imaging apparatus 1 shown in FIG. 3. As shown in FIG. 4, in a case where the rotational state of the display 6 transitions to a state of being opened by 180°from the reference state, the display 6 is disposed such that a back surface 62 on a side opposite to a side where the monitor unit 61 is provided faces the rear side of the imaging apparatus main body 2. In addition, in a case where the display 6 transitions to a state of being opened by 180°, the plate 4 is disposed such that a surface 42 of the plate 4 on which the back surface 62 of the display 6 overlaps in FIGS. 1 and 2, that is, a surface 42 on a side opposite to a side that overlaps the rear surface of the imaging apparatus main body 2 in FIGS. 1 and 2, faces the rear side of the imaging apparatus main body 2.

The back surface 62 of the display 6 is provided with a main body proximity sensor 63 that is an example of a “first proximity sensor” according to the embodiment of the present invention, a plate proximity sensor 64 that is an example of a “second proximity sensor” according to the embodiment of the present invention, and a display acceleration sensor 65 that is an example of a “first acceleration sensor” according to the embodiment of the present invention.

The main body proximity sensor 63 is a sensor capable of detecting the proximity of the imaging apparatus main body 2 in the back surface direction of the display 6. The plate proximity sensor 64 is a sensor capable of detecting the proximity of the plate 4 in the back surface direction of the display 6. For example, a photoreflector or a magnetic sensor can be used as the proximity sensor. The back surface direction of the display 6 is a direction opposite to a display direction of the monitor unit 61 in the display 6. The back surface direction is an example of a “third direction” according to the embodiment of the present invention. The display acceleration sensor 65 is a sensor capable of detecting the posture of the display 6 in the direction of gravitational force.

In the example shown in FIG. 4, the main body proximity sensor 63 is provided in an upper left portion of the back surface 62 of the display 6. Similarly, the plate proximity sensor 64 is provided in a lower left portion of the back surface 62 of the display 6. Similarly, the display acceleration sensor 65 is provided in a right central portion of the back surface 62 of the display 6.

A proximity detection hole 43 is provided in the plate 4. The proximity detection hole 43 is a detection hole used in a case where the main body proximity sensor 63 detects the proximity of the imaging apparatus main body 2. The proximity detection hole 43 is formed to penetrate the plate 4. The proximity detection hole 43 is provided at a position corresponding to the position of the main body proximity sensor 63 provided in the display 6 in a case where the display 6 is in a closed state with respect to the plate 4.

For example, the imaging apparatus 1 can detect whether or not the imaging apparatus main body 2 is close to the display 6 by using the main body proximity sensor 63 and can determine whether or not the plate 4 is in a closed state with respect to the imaging apparatus main body 2 based on the detection result. In this case, the main body proximity sensor 63 detects whether or not the imaging apparatus main body 2 is close to the display 6 through the proximity detection hole 43 provided in the plate 4. In addition, the imaging apparatus 1 can detect whether or not the plate 4 is close to the display 6 by using the plate proximity sensor 64 and can determine whether or not the display 6 is in a closed state with respect to the plate 4 based on the detection result. In addition, the imaging apparatus 1 can detect the posture of the display 6 in the direction of gravitational force by using the display acceleration sensor 65 and can determine the orientation of imaging (vertical shooting or horizontal shooting) performed by the imaging apparatus 1 based on the detection result.

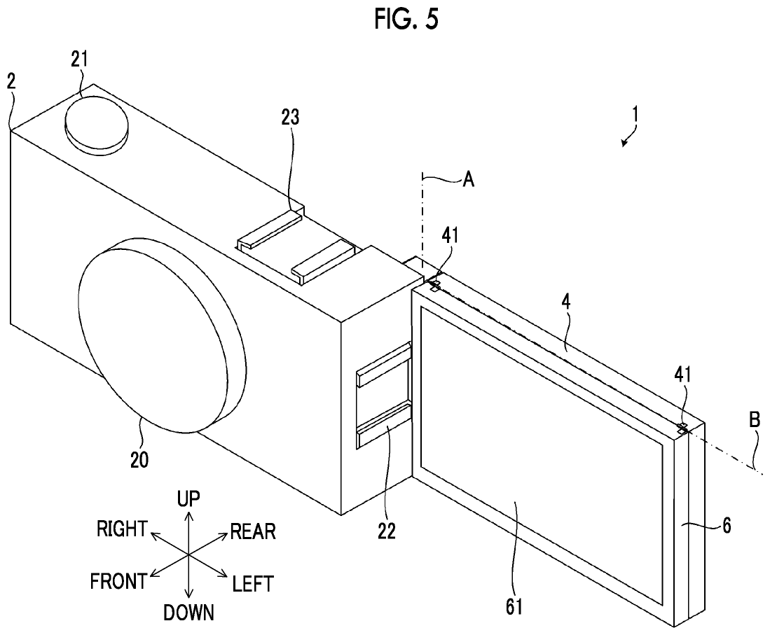

FIG. 5 is a front perspective view showing an example of a state in which the plate 4 of the imaging apparatus 1 is opened with respect to the imaging apparatus main body 2. In the imaging apparatus 1 shown in FIG. 5, the plate 4 is in a completely open state with respect to the imaging apparatus main body 2, and the display 6 is in a closed state with respect to the plate 4. That is, the imaging apparatus 1 shown in FIG. 5 is in a state where only the plate 4 is rotated around the first axis A to the maximum extent with respect to the imaging apparatus main body 2 from the reference state shown in FIGS. 1 and 2. In this rotational state, the opening/closing angle of the first hinge 31 around the first axis A is 180°, and the opening/closing angle of the second hinge 41 around the second axis B is 0°. However, since the display 6 is connected to the plate 4 by the second hinge 41, the display 6 is rotated around the first axis A together with the plate 4 as the plate 4 is in an open state with respect to the imaging apparatus main body 2.

In a case where the rotational state of the plate 4 transitions from the reference state to a state where the plate 4 is opened by 180°, the plate 4 is disposed on the left side of the imaging apparatus main body 2 to be arranged with the imaging apparatus main body 2. In addition, in a case where the plate 4 transitions to a state where the plate 4 is opened by 180°, the display 6 connected to the plate 4 is disposed at a position on the left side of the imaging apparatus main body 2 together with the plate 4 in a state where the monitor unit 61 is directed to the front side of the imaging apparatus 1. Therefore, the user can directly visually recognize the display information of the monitor unit 61 on the front surface side of the imaging apparatus main body 2 while, for example, gripping the imaging apparatus main body 2 of the imaging apparatus 1 with the hand. The display of the monitor unit 61 on the display 6 in this case is a so-called mirror-inverted display, and is configured to be suitable for the user to take a self-portrait.

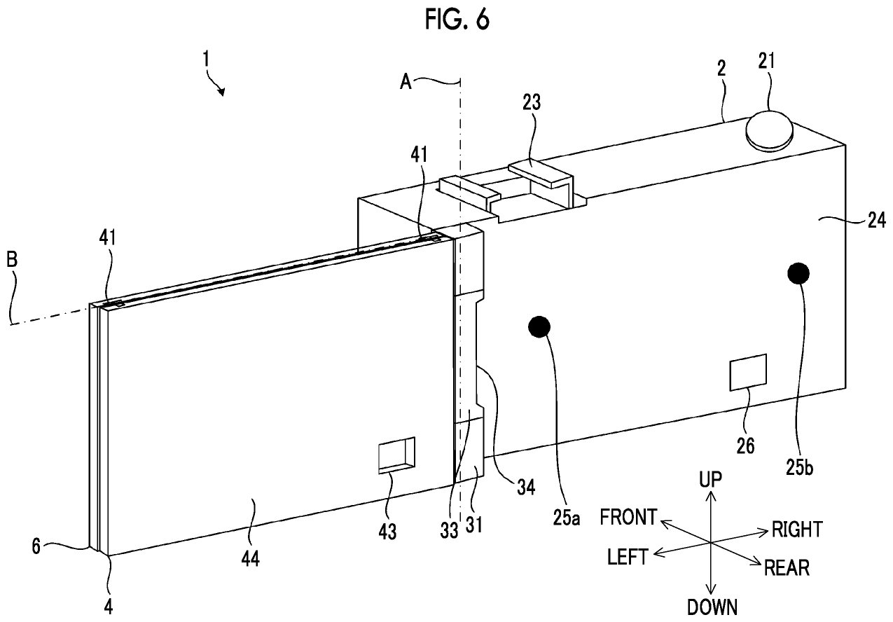

FIG. 6 is a rear perspective view of the imaging apparatus 1 shown in FIG. 5. As shown in FIG. 6, in a case where the rotational state of the plate 4 transitions from the reference state to a state where the plate 4 is opened by 180°, the imaging apparatus main body 2 is disposed in a state where the rear surface 24 is exposed on the rear side. In addition, the plate 4 is disposed on the left side of the imaging apparatus main body 2 by transitioning to a state where the plate 4 is opened by 180°, and the surface 44 of the plate 4 that overlaps the rear surface 24 of the imaging apparatus main body 2 in FIGS. 1 and 2 is disposed to face the rear side of the imaging apparatus 1.

The imaging apparatus main body 2 can attach a cooling device for cooling the imaging apparatus main body 2 in a case where the plate 4 is in a state of being opened with respect to the imaging apparatus main body 2. The cooling device is, for example, an external fan. The cooling device is an example of a “predetermined device” according to the embodiment of the present invention. The open state is a state other than the “closed state”, and is not limited to the state where the plate 4 is opened by 180° as shown in FIG. 6, and may be a state where the plate 4 is opened by 180° or less. The state where the plate 4 is opened with respect to the imaging apparatus main body 2 is the “second state” of the first hinge 31.

The rear surface 24 of the imaging apparatus main body 2 is provided with screw holes 25a and 25b for attaching the cooling device and an electronic contact 26 of the cooling device for supplying power to the attached cooling device.

In addition, in a case where the plate 4 is in a state of being opened with respect to the imaging apparatus main body 2, the rotating portion 33 also rotates together with the rotation of the plate 4. Thus, the position of the recessed portion 34 of the rotating portion 33 changes from the left side to the right side of the rotating portion 33 in accordance with the rotation. As described above, in a case where the plate 4 is in a state of being opened with respect to the imaging apparatus main body 2 and the position of the recessed portion 34 is changed, the first accessory shoe 22 is in a state of not being exposed in a case of being viewed from the rear side of the imaging apparatus 1. Thus, the accessory device cannot be inserted into the first accessory shoe 22 from the rearward direction of the imaging apparatus main body 2.

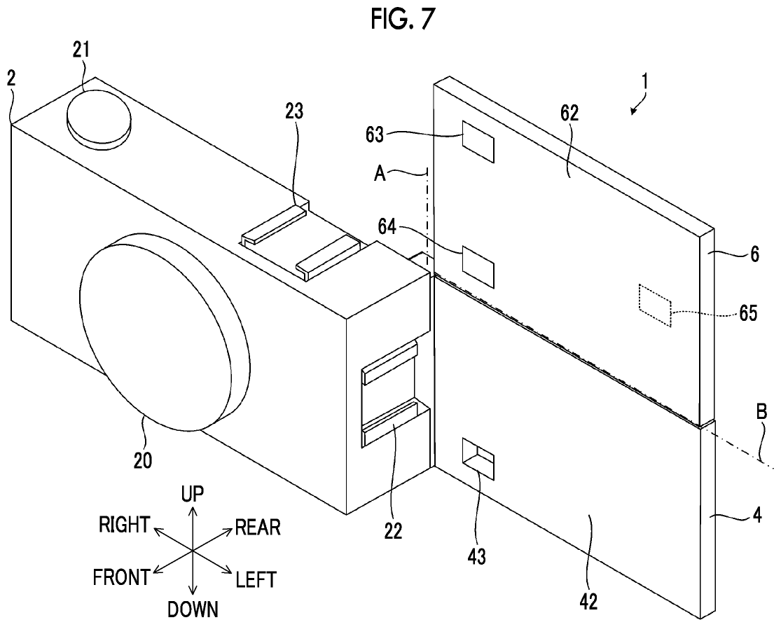

FIG. 7 is a front perspective view showing an example of a state in which the plate 4 of the imaging apparatus 1 is opened with respect to the imaging apparatus main body 2 and the display 6 is further opened with respect to the plate 4. In the imaging apparatus 1 shown in FIG. 7, the plate 4 is in a state of being completely opened with respect to the imaging apparatus main body 2, and the display 6 is in a state of being completely opened with respect to the plate 4. That is, the imaging apparatus 1 shown in FIG. 7 is in a state where the plate 4 is rotated around the first axis A to the maximum extent with respect to the imaging apparatus main body 2 and the display 6 is rotated around the second axis B to the maximum extent with respect to the plate 4 from the reference state shown in FIGS. 1 and 2. In this rotational state, the opening/closing angle of the first hinge 31 around the first axis A is 180°, and the opening/closing angle of the second hinge 41 around the second axis B is 180°. In other words, the imaging apparatus 1 shown in FIG. 7 is in a state where the display 6 of the imaging apparatus 1 shown in FIG. 5 is rotated by 180° around the second axis B. Alternatively, the imaging apparatus 1 shown in FIG. 7 is in a state where the plate 4 of the imaging apparatus 1 shown in FIG. 3 is rotated by 180° around the first axis A.

In a case where the plate 4 transitions to a state of being opened by 180° and the display 6 transitions to a state of being opened by 180°, the plate 4 is disposed on the left side of the imaging apparatus main body 2 to be arranged with the imaging apparatus main body 2, and the surface 42 of the plate 4 that overlaps the back surface 62 of the display 6 in FIGS. 1 and 2 is disposed to face the front side of the imaging apparatus 1. In addition, in a case where the plate 4 transitions to a state of being opened by 180° and the display 6 transitions to a state of being opened by 180°, the display 6 is disposed on the upper side of the plate 4 to be arranged with the plate 4 in the up-down direction, and the back surface 62 of the display 6 that overlaps the surface 42 of the plate 4 in FIGS. 1 and 2, that is, the back surface 62 on a side opposite to a side on which the monitor unit 61 is provided, is disposed to face the front side of the imaging apparatus 1.

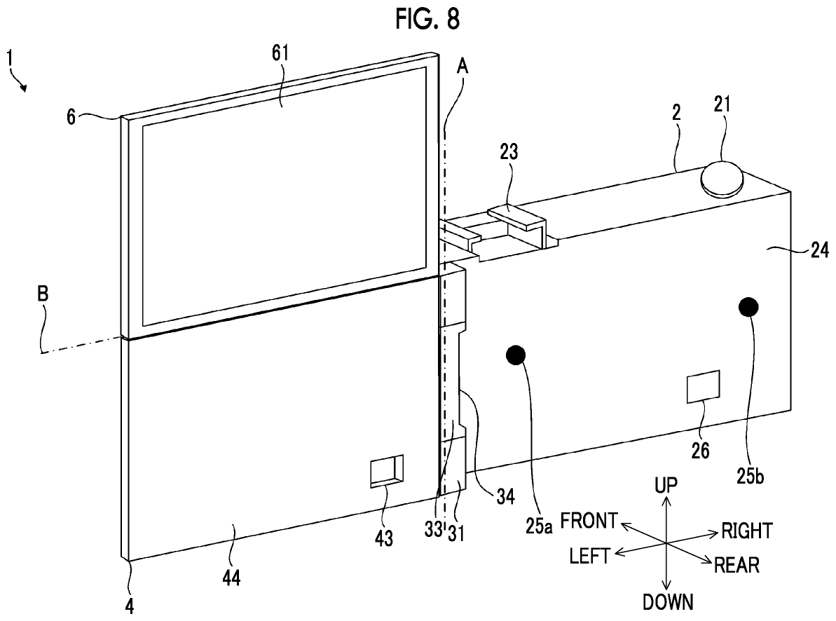

FIG. 8 is a rear perspective view of the imaging apparatus 1 shown in FIG. 7. As shown in FIG. 8, in a case where the plate 4 transitions to a state of being opened by 180° and the display 6 transitions to a state of being opened by 180°, the imaging apparatus main body 2 is disposed in a state where the rear surface 24 is exposed on the rear side. In addition, in a case where the plate 4 transitions to a state of being opened by 180° and the display 6 transitions to a state of being opened by 180°, the plate 4 is disposed on the left side of the imaging apparatus main body 2, and the surface 44 of the plate 4 that overlaps the rear surface 24 of the imaging apparatus main body 2 in FIGS. 1 and 2 is disposed to face the rear side of the imaging apparatus 1. In addition, in a case where the plate 4 transitions to a state of being opened by 180° and the display 6 transitions to a state of being opened by 180°, the display 6 is disposed on the upper side of the plate 4, and the monitor unit 61 is disposed to face the rear side of the imaging apparatus 1.

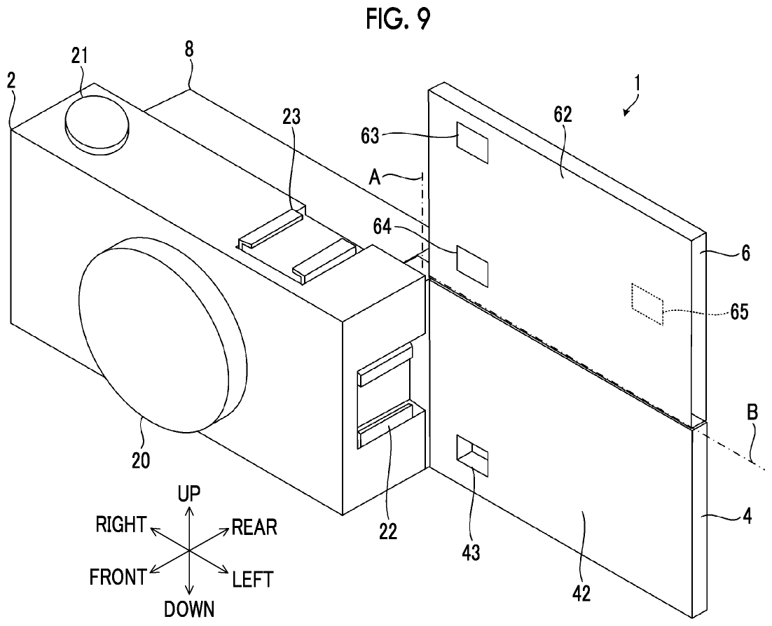

FIG. 9 is a front perspective view showing an example of the imaging apparatus 1 in which the cooling device 8 is attached to the rear surface 24 of the imaging apparatus main body 2. As shown in FIG. 9, the cooling device 8 can be attached to the imaging apparatus main body 2 in a case where the rotational state of the first hinge 31 is a state where the plate 4 is opened with respect to the imaging apparatus main body 2. In the imaging apparatus 1 shown in FIG. 9, the plate 4 is opened by 180° with respect to the imaging apparatus main body 2, and the display 6 is in a state of being opened by 180° with respect to the plate 4.

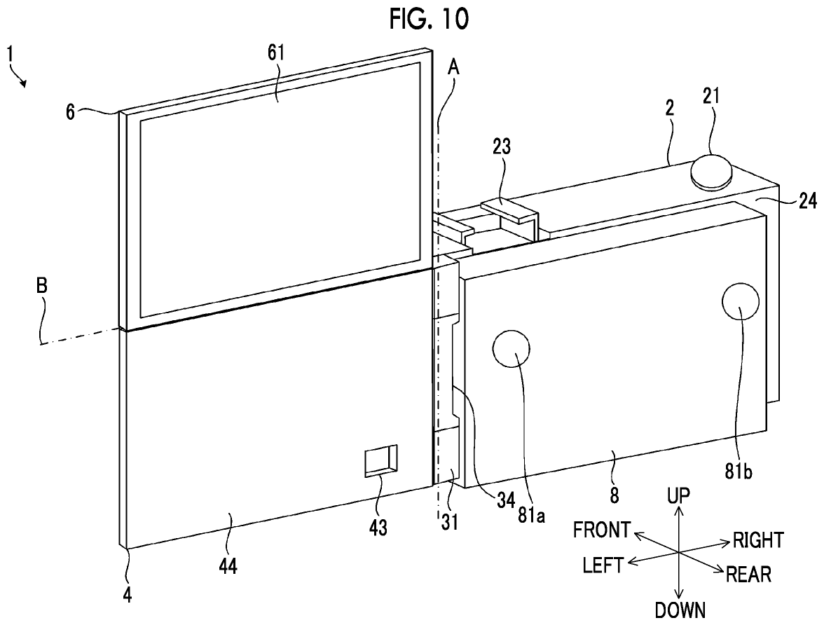

FIG. 10 is a rear perspective view of the imaging apparatus 1 shown in FIG. 9. As shown in FIG. 10, the cooling device 8 is attached to the rear surface 24 of the imaging apparatus main body 2 via screw holes 25a and 25b (see FIG. 8) provided in the rear surface 24 by screws 81a and 81b. In addition, the cooling device 8 is attached in a state where an electronic contact (not shown) provided in the cooling device 8 is connected to the electronic contact 26 (see FIG. 8) provided in the rear surface 24 of the imaging apparatus main body 2.

The imaging form by the imaging apparatus 1 in FIGS. 9 and 10 is a form in which the orientation of the lens 20 of the imaging apparatus main body 2 and the orientation of the monitor unit 61 of the display 6 are set to be opposite to each other, that is, a form used in so-called normal imaging in which the imaging direction of the imaging apparatus 1 and the display direction of the monitor unit 61 are opposite to each other.

It should be noted that, as the form of the imaging apparatus 1 to which the cooling device 8 can be attached, the imaging apparatus 1 in a state where the plate 4 and the display 6 are opened by 180° is shown in the example shown in FIG. 9, but the present invention is not limited to this rotational state. For example, as shown in FIGS. 5 and 6, the cooling device 8 can be attached to the imaging apparatus main body 2 even in a state where only the plate 4 is opened.

### Hardware Configuration of Imaging Apparatus Main Body 2

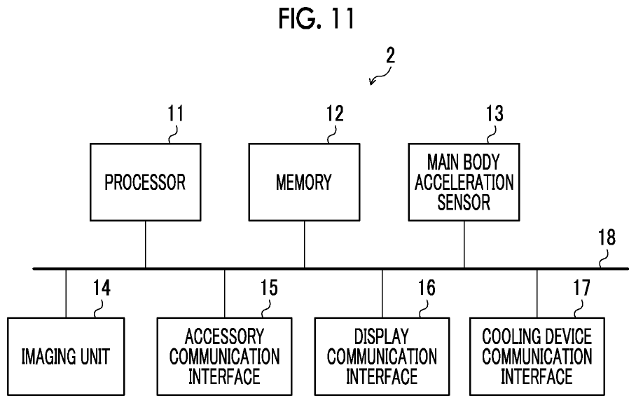

FIG. 11 is a diagram showing an example of a hardware configuration of the imaging apparatus main body 2. As shown in FIG. 11, the imaging apparatus main body 2 comprises a processor 11, a memory 12, a main body acceleration sensor 13, an imaging unit 14, an accessory communication interface 15, a display communication interface 16, and a cooling device communication interface 17. The processor 11, the memory 12, the main body acceleration sensor 13, the imaging unit 14, the accessory communication interface 15, the display communication interface 16, and the cooling device communication interface 17 are connected to each other by, for example, a bus 18.

The processor 11 is a circuit that performs signal processing, and is, for example, a CPU that controls the entire imaging apparatus main body 2. The processor 11 may be implemented by other digital circuits such as an FPGA and a digital signal processor (DSP). The processor 11 may be implemented by a combination of a plurality of digital circuits.

The memory 12 includes, for example, a main memory and an auxiliary memory. For example, the main memory is a random-access memory (RAM). The main memory is used as a work area of the processor 11. For example, the auxiliary memory is a non-volatile memory such as a magnetic disk or a flash memory. The auxiliary memory stores various programs for operating the imaging apparatus main body 2. The programs stored in the auxiliary memory are loaded into the main memory and executed by the processor 11. In addition, the auxiliary memory may include a portable memory that is detachable from the imaging apparatus main body 2. Examples of the portable memory include a universal serial bus (USB) flash drive, a memory card such as a secure digital (SD) memory card, and an external hard disk drive.

The main body acceleration sensor 13 is a sensor capable of detecting a posture of the imaging apparatus main body 2 in a direction of gravitational force. The processor 11 can determine an imaging orientation (vertical shooting or horizontal shooting) of the imaging apparatus 1 based on a detection result of the main body acceleration sensor 13. In addition, the processor 11 can determine a relative positional relationship between the imaging apparatus main body 2 and the display 6 based on the main body acceleration sensor 13 and the detection result of the main body acceleration sensor 13. The main body acceleration sensor 13 is an example of a “second acceleration sensor” according to the embodiment of the present invention.

The imaging unit 14 includes a lens 20 and an imaging element. The lens 20 includes at least an imaging lens such as a focus lens or a zoom lens. The imaging element can be configured with, for example, a charge coupled device (CCD) image sensor or a complementary metal oxide semiconductor (CMOS) image sensor. In addition, the imaging unit 14 includes a signal processing circuit that performs sampling processing, digital conversion processing, and the like on a captured image signal output from the imaging element. In addition, the imaging unit 14 includes an image processing unit that generates captured image data in a format such as joint photographic experts group (JPEG) format by performing digital signal processing on the captured image signal processed by the signal processing circuit.

The accessory communication interface 15 is a communication interface that performs communication between a first accessory shoe 22 and a second accessory shoe 23 provided in the imaging apparatus main body 2.

The display communication interface 16 is a communication interface that performs communication with the display 6.

The cooling device communication interface 17 is a communication interface that performs communication with the cooling device 8 attached to the imaging apparatus main body 2. As described above, the cooling device 8 is attached in a state in which an electronic contact of the cooling device 8 is connected to the electronic contact 26 of the imaging apparatus main body 2. The cooling device communication interface 17 can detect presence or absence of attachment of the cooling device to the imaging apparatus main body 2 together with the electronic contact 26. The cooling device communication interface 17 and the electronic contact 26 (see FIG. 8) are examples of an “attachment sensor” according to the embodiment of the present invention.

For example, the processor 11 controls display information to be displayed on the monitor unit 61 based on the posture of the display 6 in the direction of gravitational force detected by the display acceleration sensor 65, the proximity state of the imaging apparatus main body 2 in the back surface direction of the display 6 detected by the main body proximity sensor 63, and the proximity state of the plate 4 in the back surface direction of the display 6 detected by the plate proximity sensor 64. Specifically, the processor 11 determines the imaging orientation (vertical shooting or horizontal shooting) from the detection result of the display acceleration sensor 65, determines the open/closed state (roughly open or closed state) of each hinge from the detection results of the main body proximity sensor 63 and the plate proximity sensor 64, and controls the display of the monitor unit 61 (inversion processing in up, down, left, and right directions) based on the determination results.

In addition, the processor 11 controls display information to be displayed on the monitor unit 61 based on the information detected by the display acceleration sensor 65, the main body proximity sensor 63, and the plate proximity sensor 64, and the presence or absence of attachment of the cooling device 8 detected by the cooling device communication interface 17 (attachment sensor). For example, in a case where the cooling device 8 is attached, the processor 11 determines that the plate 4 is in an open state with respect to the imaging apparatus main body 2 by detecting the attachment of the cooling device 8 by the cooling device communication interface 17 (attachment sensor).

In addition, the processor 11 controls display information to be displayed on the monitor unit 61 based on the information detected by the display acceleration sensor 65, the main body proximity sensor 63, the plate proximity sensor 64, and the cooling device communication interface 17, and the posture of the imaging apparatus main body 2 in the direction of gravitational force detected by the main body acceleration sensor 13. Specifically, the processor 11 determines the imaging orientation (vertical shooting or horizontal shooting) from the detection results of the display acceleration sensor 65 and the main body acceleration sensor 13, determines the open/closed state (roughly open or closed state) of each hinge from the detection results of the main body proximity sensor 63, the plate proximity sensor 64, and the cooling device communication interface 17, and controls the display of the monitor unit 61 (inversion processing in up, down, left, and right directions) based on the determination results.

### Connection Example of Imaging Apparatus Main Body 2 and Display 6

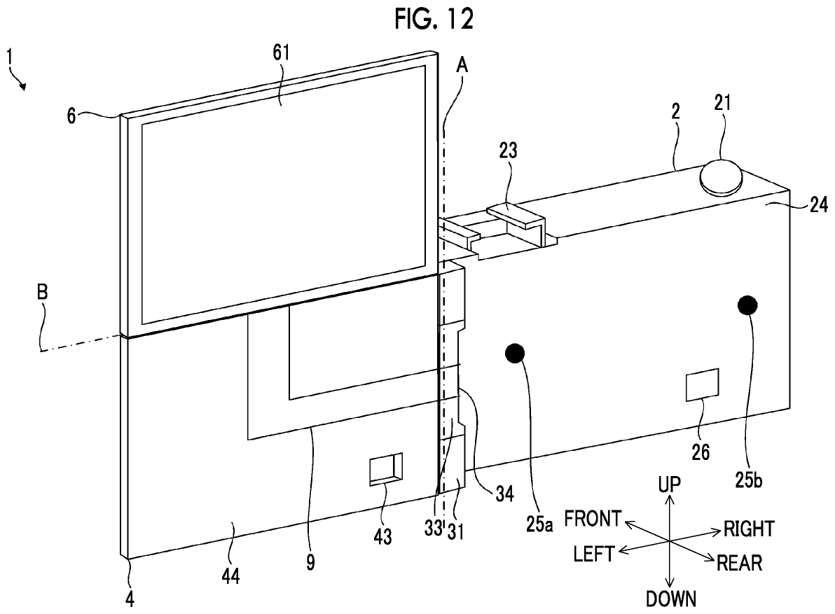

FIG. 12 is a diagram showing an example of connection between the imaging apparatus main body 2 and the display 6. As shown in FIG. 12, the imaging apparatus main body 2 and the display 6 are electrically connected to each other by a flexible printed circuit (FPC) 9 which is an example of a “flexible electronic substrate” according to the embodiment of the present invention. The FPC 9 in the present example is formed in an L-shape, is disposed on the plate 4, and is fixed to the plate 4 by, for example, having a shielding sheet attached thereto. The imaging apparatus main body 2 performs display control of information displayed on the monitor unit 61 of the display 6 via the FPC 9. In addition, the imaging apparatus main body 2 acquires information of the main body proximity sensor 63, the plate proximity sensor 64, and the display acceleration sensor 65 provided in the display 6 via the FPC 9.

### Display Control by Processor 11 of Imaging Apparatus Main Body 2

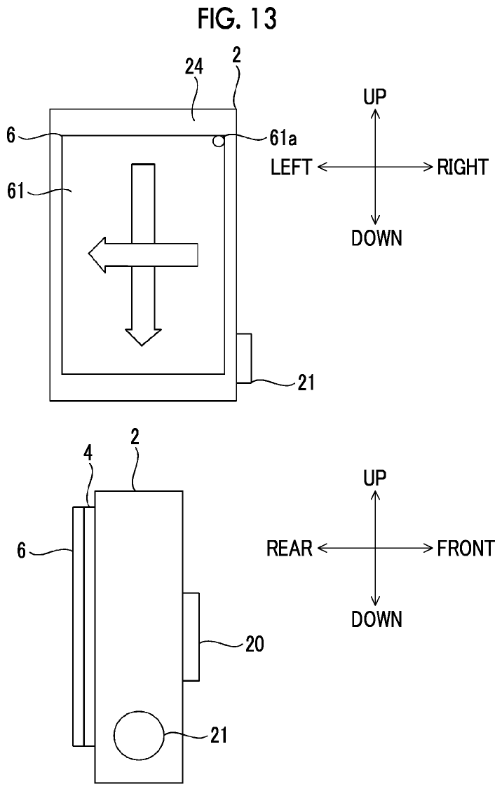

Next, the display control performed by the processor 11 in various imaging forms in the imaging apparatus 1 will be described below. First, display control of a vertical shooting form in the imaging apparatus 1 will be described with reference to FIGS. 13 to 17.

FIG. 13 is a diagram showing a first form of vertical shooting in the imaging apparatus 1. In FIG. 13, a rear view (upper diagram) of the imaging apparatus 1 as viewed from the rear surface 24 side of the imaging apparatus main body 2 and a right side view (lower diagram) of the imaging apparatus 1 as viewed from the release button 21 side are shown.

In the case of the first form, the processor 11 detects the posture of the display 6 in the direction of gravitational force by the display acceleration sensor 65 and detects the posture of the imaging apparatus main body 2 in the direction of gravitational force by the main body acceleration sensor 13, and thus, determines that the imaging form of the imaging apparatus 1 is the form of the vertical shooting in which the release button 21 is disposed on the lower side. In addition, the processor 11 detects the proximity state of the plate 4 in the back surface direction of the display 6 by the plate proximity sensor 64, and thus, determines that the display 6 is in a closed state with respect to the plate 4. In addition, the processor 11 detects the proximity state of the imaging apparatus main body 2 in the back surface direction of the display 6 by the main body proximity sensor 63, and thus, determines that the plate 4 is in a closed state with respect to the imaging apparatus main body 2.

Based on the determination results, the processor 11 determines that the imaging form of the imaging apparatus 1 is the “vertical shooting_upright position form” in which the release button 21 of the imaging apparatus main body 2 is disposed on the lower side, the monitor unit 61 of the display 6 is disposed to face the rear side of the imaging apparatus 1, and the display 6 with the monitor unit 61 facing the rear side is disposed to be superimposed on the rear surface 24 of the imaging apparatus main body 2. The processor 11 performs control of displaying information corresponding to the vertical shooting_upright position form on the monitor unit 61 based on the determination result.

For example, the processor 11 performs display control of the monitor unit 61 by using a position of an upper right end of the monitor unit 61 in the rear view as a display origin 61a. In addition, the processor 11 performs display control by defining a horizontal direction and a vertical direction of the monitor unit 61 in the vertical shooting_upright position form as a direction of a horizontal arrow and a direction of a vertical arrow shown in FIG. 13. For example, the processor 11 may perform display control of scanning in the direction of the horizontal arrow and the direction of the vertical arrow. The display state of the monitor unit 61 of the display 6 in this case is referred to as “normal display” of the vertical shooting. In the normal display, the user can directly visually recognize the display information of the monitor unit 61 on the rear surface side of the imaging apparatus main body 2, for example, while gripping the imaging apparatus main body 2 of the imaging apparatus 1 with the hand.

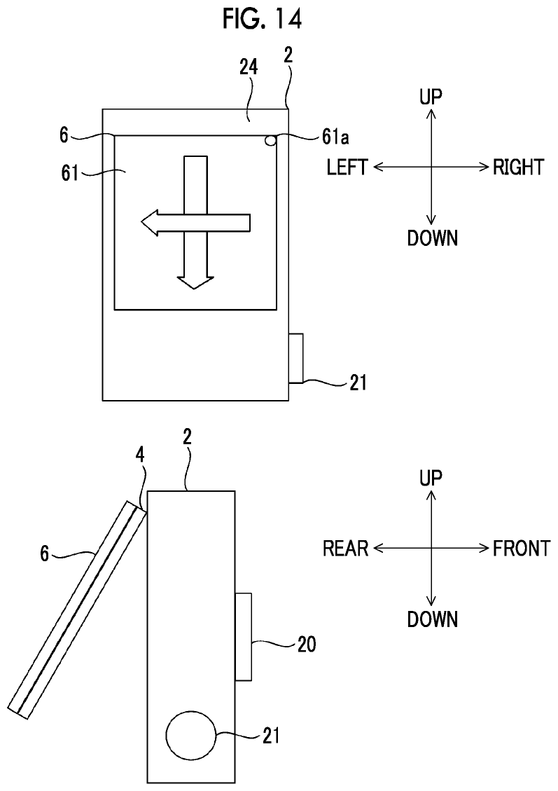

FIG. 14 is a diagram showing a second form of the vertical shooting in the imaging apparatus 1. In FIG. 14, a rear view of the imaging apparatus 1 as viewed from the rear surface 24 side of the imaging apparatus main body 2 and a right side view of the imaging apparatus 1 as viewed from the release button 21 side are shown, as in FIG. 13.

In the case of the second form, the processor 11 determines that the imaging form of the imaging apparatus 1 is the form of the vertical shooting in which the release button 21 is disposed on the lower side, by the posture detection of the display 6 via the display acceleration sensor 65 and the posture detection of the imaging apparatus main body 2 via the main body acceleration sensor 13, as in the first form. In addition, the processor 11 detects the proximity state of the plate 4 in the back surface direction of the display 6 by the plate proximity sensor 64, and thus, determines that the display 6 is in a closed state with respect to the plate 4. In addition, the processor 11 determines that the plate 4 is in the state of being opened by 90° or less with respect to the imaging apparatus main body 2 by detecting the remote state of the imaging apparatus main body 2 in the back surface direction of the display 6 via the main body proximity sensor 63 and combining the result of the posture detection of the imaging apparatus main body 2 via the main body acceleration sensor 13 and the result of the posture detection of the display 6 via the display acceleration sensor 65.

Based on the determination results, the processor 11 determines that the imaging form of the imaging apparatus 1 is the “vertical shooting_low-angle form” in which the release button 21 of the imaging apparatus main body 2 is disposed on the lower side, the monitor unit 61 of the display 6 is disposed to face the rear side of the imaging apparatus 1, and the display 6 with the monitor unit 61 facing the rear side is disposed to be opened at an angle of 90° or less (about 30° in the present example) from the rear surface 24 of the imaging apparatus main body 2. The processor 11 performs control of displaying information corresponding to the vertical shooting_low-angle form on the monitor unit 61 based on the determination result. For example, the processor 11 performs control of normally displaying the information on the monitor unit 61, as in the first form. In this case, the user can visually recognize the display information of the monitor unit 61 at the low angle on the rear surface side of the imaging apparatus main body 2 while gripping the imaging apparatus main body 2 of the imaging apparatus 1 with the hand, for example.

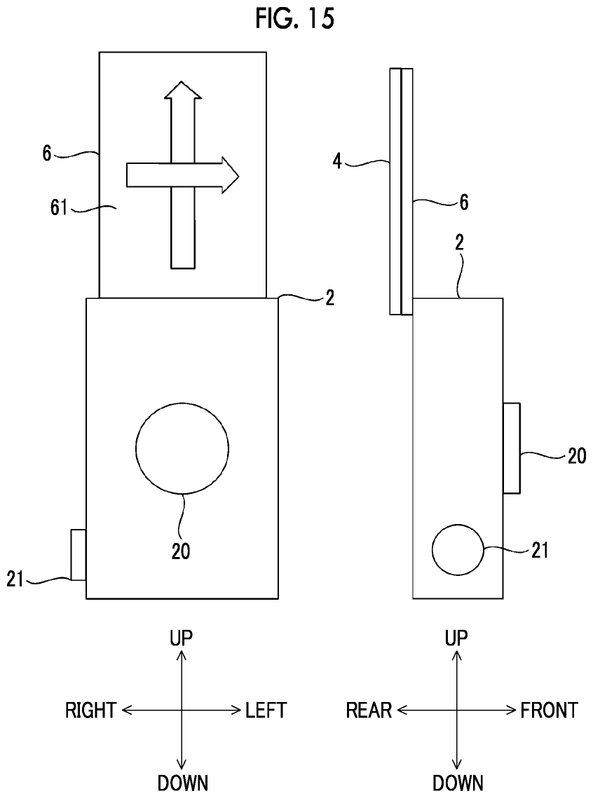

FIG. 15 is a diagram showing a third form of the vertical shooting in the imaging apparatus 1. In FIG. 15, a front view (left diagram) of the imaging apparatus 1 as viewed from the lens 20 side of the imaging apparatus main body 2 and a right side view (right diagram) of the imaging apparatus 1 as viewed from the release button 21 side are shown.

In the case of the third form, the processor 11 detects the posture of the display 6 in the direction of gravitational force via the display acceleration sensor 65 and detects the posture of the imaging apparatus main body 2 in the direction of gravitational force via the main body acceleration sensor 13, and thus determines that the imaging form of the imaging apparatus 1 is the form of the vertical shooting in which the release button 21 of the imaging apparatus main body 2 is disposed on the lower side and the display 6 is disposed on the upper side with respect to the imaging apparatus main body 2. In addition, the processor 11 detects the proximity state of the plate 4 in the back surface direction of the display 6 by the plate proximity sensor 64, and thus, determines that the display 6 is in a closed state with respect to the plate 4. In addition, the processor 11 detects the remote state of the imaging apparatus main body 2 in the back surface direction of the display 6 via the main body proximity sensor 63, and combines the result of the posture detection of the imaging apparatus main body 2 via the main body acceleration sensor 13 and the result of the posture detection of the display 6 via the display acceleration sensor 65, and thus determines that the plate 4 is in the state of being opened by more than 90° with respect to the imaging apparatus main body 2.

Based on the determination results, the processor 11 determines that the imaging form of the imaging apparatus 1 is the “vertical shooting_upper position form” in which the release button 21 of the imaging apparatus main body 2 is disposed on the lower side, the monitor unit 61 of the display 6 is disposed to face the front of the imaging apparatus 1, and the display 6 with the monitor unit 61 facing the front is disposed to be opened in the upward direction of the imaging apparatus main body 2 at an angle (180° in the present example) more than 90° from the rear surface 24 of the imaging apparatus main body 2.

In the display 6 of FIG. 15 in the vertical shooting_upper position form, the position of the display origin 61a, which is the upper right end of the monitor unit 61 in FIG. 13, is the position of the lower left end of the monitor unit 61 in FIG. 15. In addition, in the monitor unit 61 in FIG. 15, both the direction of the horizontal arrow and the direction of the vertical arrow of the monitor unit 61 defined in FIG. 13 are opposite to the arrow directions in FIG. 13. Therefore, the processor 11 performs the display control of the monitor unit 61 corresponding to the vertical shooting_upper position form.

For example, the processor 11 performs the conversion processing of vertically inverting the display state of the monitor unit 61 with respect to the normal display of the vertical shooting, and displays the converted information on the monitor unit 61. The display state of the monitor unit 61 of the display 6 in this case is referred to as, for example, “vertically inverted display” of the vertical shooting. With the vertically inverted display, even in a case where the display 6 is vertically inverted about the first axis A of the first hinge 31, the information and the like are displayed on the monitor unit 61 of the display 6 such that the user can easily visually recognize the information and the like. In this case, for example, the user can directly visually recognize the display information of the monitor unit 61 on the front surface side of the imaging apparatus main body 2 while gripping the imaging apparatus main body 2 of the imaging apparatus 1 with the hand, and can take a self-portrait.

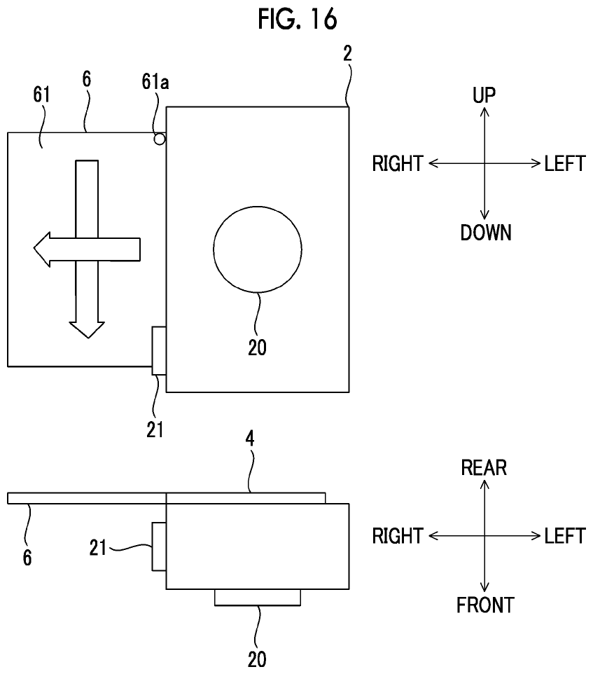

FIG. 16 is a diagram showing a fourth form of the vertical shooting in the imaging apparatus 1. In FIG. 16, a front view (upper diagram) in which the imaging apparatus 1 is viewed from the lens 20 side of the imaging apparatus main body 2 and a top view (lower diagram) in which the imaging apparatus 1 is viewed from the upper side (the first accessory shoe 22 side) are shown.

In the case of the fourth form, the processor 11 detects the posture of the display 6 in the direction of gravitational force by the display acceleration sensor 65 and detects the posture of the imaging apparatus main body 2 in the direction of gravitational force by the main body acceleration sensor 13, and thus determines that the imaging form of the imaging apparatus 1 is the form of the vertical shooting in which the release button 21 of the imaging apparatus main body 2 is disposed on the lower side. In addition, the processor 11 detects the remote state of the plate 4 in the back surface direction of the display 6 by the plate proximity sensor 64, and determines that the display 6 is in the open state with respect to the plate 4. In addition, the processor 11 detects the remote state of the imaging apparatus main body 2 in the back surface direction of the display 6 by the main body proximity sensor 63, and combines the detection result of the remote state of the plate 4 by the plate proximity sensor 64, the detection result of the posture of the imaging apparatus main body 2 by the main body acceleration sensor 13, and the detection result of the posture of the display 6 by the display acceleration sensor 65, and thus determines that the plate 4 is in the closed state with respect to the imaging apparatus main body 2.

Based on the determination results, the processor 11 determines that the imaging form of the imaging apparatus 1 is the “vertical shooting_horizontal position form” in which the release button 21 of the imaging apparatus main body 2 is disposed on the lower side, the monitor unit 61 of the display 6 is disposed to face the front of the imaging apparatus 1, and the display 6 with the monitor unit 61 facing the front is disposed on the right side of the imaging apparatus main body 2. The processor 11 performs control of displaying information corresponding to the vertical shooting_horizontal position form on the monitor unit 61 based on the determination result. In the display 6 of FIG. 16 in the vertical shooting_horizontal position form, the position of the display origin 61a in the monitor unit 61 and the orientations of the horizontal arrow and the vertical arrow are the same as the position and the orientations thereof described in FIG. 13. The display state of the monitor unit 61 of the display 6 in this case is referred to as “mirror-inverted display” of the vertical shooting. In the mirror-inverted display, for example, the user can directly visually recognize the display information of the monitor unit 61 on the front surface side of the imaging apparatus main body 2 while gripping the imaging apparatus main body 2 of the imaging apparatus 1 with the hand, and thus can take a self-portrait.

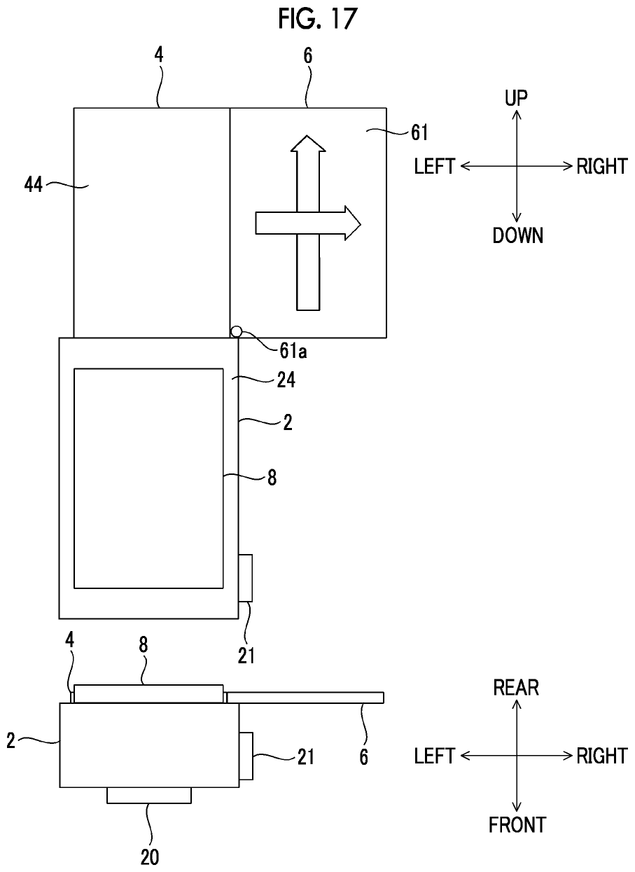

FIG. 17 is a diagram showing a fifth form of the vertical shooting in the imaging apparatus 1. In FIG. 17, a rear view (upper diagram) in which the imaging apparatus 1 is viewed from the side of the rear surface 24 of the imaging apparatus main body 2 and a bottom view (lower diagram) in which the imaging apparatus 1 is viewed from the lower side (side of the first accessory shoe 22) are shown. In the example shown in FIG. 17, the cooling device 8 is attached to the rear surface 24 of the imaging apparatus main body 2.

In the case of the fifth form, the processor 11 detects the posture of the display 6 in the direction of gravitational force by the display acceleration sensor 65 and detects the posture of the imaging apparatus main body 2 in the direction of gravitational force by the main body acceleration sensor 13, and thus determines that the imaging form of the imaging apparatus 1 is the form of the vertical shooting in which the release button 21 of the imaging apparatus main body 2 is disposed on the lower side and the display 6 is disposed on the upper side with respect to the imaging apparatus main body 2. In addition, the processor 11 detects the remote state of the plate 4 in the back surface direction of the display 6 by the plate proximity sensor 64, and thus determines that the display 6 is in the open state with respect to the plate 4. In addition, the processor 11 detects the remote state of the imaging apparatus main body 2 in the back surface direction of the display 6 by the main body proximity sensor 63, and combines the detection result of the remote state of the plate 4 by the plate proximity sensor 64, the detection result of the posture of the imaging apparatus main body 2 by the main body acceleration sensor 13, and the detection result of the posture of the display 6 by the display acceleration sensor 65, and thus determines that the plate 4 is in the state of being opened by more than 90° with respect to the imaging apparatus main body 2. In addition, the processor 11 detects the connection state of the electronic contact of the cooling device 8 with respect to the electronic contact 26 of the imaging apparatus main body 2 by the cooling device communication interface 17, and thus determines that the cooling device 8 is attached to the rear surface 24 of the imaging apparatus main body 2.

Based on the determination results, the processor 11 determines that the imaging form of the imaging apparatus 1 is the “vertical shooting_cooling device mounting form” in which the release button 21 of the imaging apparatus main body 2 is disposed on the lower side, the monitor unit 61 of the display 6 is disposed to face the rear side of the imaging apparatus 1, the display 6 with the monitor unit 61 facing the rear side is opened in the upward direction at an angle (180° in the present example) more than 90° from the rear surface 24 of the imaging apparatus main body 2, and the plate 4 is disposed on the right side.

In the display 6 of FIG. 17 in the vertical shooting_cooling device mounting form, the position of the display origin 61a, which is the upper right end of the monitor unit 61 in FIG. 13, is the position of the lower left end of the monitor unit 61 in FIG. 17. In addition, in the monitor unit 61 in FIG. 17, both the direction of the horizontal arrow and the direction of the vertical arrow of the monitor unit 61 defined in FIG. 13 are opposite to the arrow directions in FIG. 13. Therefore, the processor 11 performs the display control of the monitor unit 61 corresponding to the vertical shooting_cooling device mounting form.

For example, the processor 11 performs the conversion processing of vertically inverting the display state of the monitor unit 61 with respect to the normal display of the vertical shooting, and displays the converted information on the monitor unit 61. The display state of the monitor unit 61 of the display 6 in this case is referred to as “mirror and vertically inverted display” of the vertical shooting. With the mirror and vertically inverted display, even in a case where the display 6 is vertically inverted about the first axis A of the first hinge 31, the information and the like are displayed on the monitor unit 61 of the display 6 such that the user can easily visually recognize the information and the like. In this case, the user can directly visually recognize the display information of the monitor unit 61 on the rear surface side of the imaging apparatus main body 2 while gripping the imaging apparatus main body 2 of the imaging apparatus 1 on which the cooling device 8 is mounted with the hand, for example, without using a low angle.

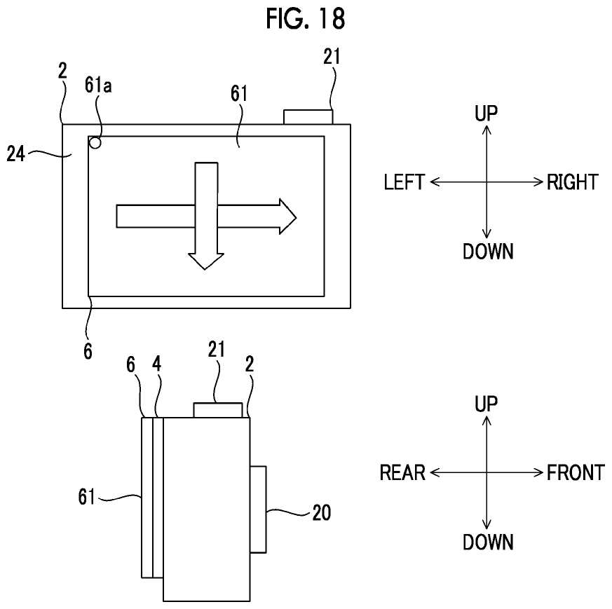

Next, the display control of the horizontal shooting form in the imaging apparatus 1 will be described with reference to FIGS. 18 to 23.

FIG. 18 is a diagram showing a first form of horizontal shooting in the imaging apparatus 1. In FIG. 18, a rear view (upper diagram) of the imaging apparatus 1 as viewed from the rear surface 24 side of the imaging apparatus main body 2 and a right side view (lower diagram) of the imaging apparatus 1 are shown.

In the case of the first form, the processor 11 detects the posture of the display 6 in the direction of gravitational force with the display acceleration sensor 65 and detects the posture of the imaging apparatus main body 2 in the direction of gravitational force with the main body acceleration sensor 13, thereby determining that the imaging form of the imaging apparatus 1 is the horizontal shooting form in which the release button 21 is disposed at the upper right. In addition, the processor 11 detects the proximity state of the plate 4 in the back surface direction of the display 6 by the plate proximity sensor 64, and thus, determines that the display 6 is in a closed state with respect to the plate 4. In addition, the processor 11 detects the proximity state of the imaging apparatus main body 2 in the back surface direction of the display 6 by the main body proximity sensor 63, and thus, determines that the plate 4 is in a closed state with respect to the imaging apparatus main body 2.

Based on the determination results, the processor 11 determines that the imaging form of the imaging apparatus 1 is a “horizontal shooting_upright position form” in which the release button 21 of the imaging apparatus main body 2 is disposed at the upper right, the monitor unit 61 of the display 6 is disposed to face the rear side of the imaging apparatus 1, and the display 6 with the monitor unit 61 facing the rear side is disposed to be superimposed on the rear surface 24 of the imaging apparatus main body 2. The processor 11 performs control of displaying information corresponding to the horizontal shooting_upright position form on the monitor unit 61 based on the determination result.

For example, the processor 11 performs display control of the monitor unit 61 by using the position of the upper left end of the monitor unit 61 in the rear view as a display origin 61a. In addition, the processor 11 performs display control by defining the horizontal direction and the vertical direction of the monitor unit 61 in the horizontal shooting_upright position form as the direction of the horizontal arrow and the direction of the vertical arrow shown in FIG. 18. For example, the processor 11 may perform display control of scanning in the direction of the horizontal arrow and the direction of the vertical arrow. The display state of the monitor unit 61 of the display 6 in this case is referred to as “normal display” of horizontal shooting. In the normal display, the user can directly visually recognize the display information of the monitor unit 61 on the rear surface side of the imaging apparatus main body 2, for example, while gripping the imaging apparatus main body 2 of the imaging apparatus 1 with the hand.

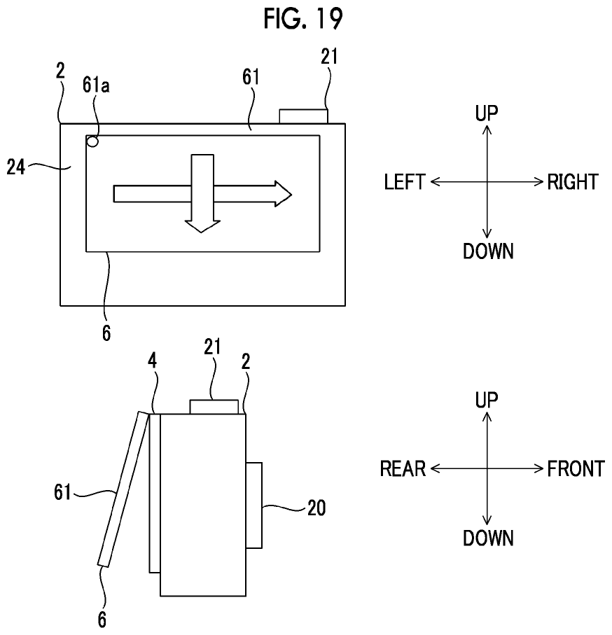

FIG. 19 is a diagram showing a second form of the horizontal shooting in the imaging apparatus 1. In FIG. 19, a rear view of the imaging apparatus 1 and a right side view of the imaging apparatus 1 are shown, as in FIG. 18.

In the case of the second form, the processor 11 determines that the imaging form of the imaging apparatus 1 is the form of the horizontal shooting in which the release button 21 is disposed at the upper right, by the posture detection of the display 6 via the display acceleration sensor 65 and the posture detection of the imaging apparatus main body 2 via the main body acceleration sensor 13, as in the first form of FIG. 18. In addition, the processor 11 detects the remote state of the plate 4 in the back surface direction of the display 6 by the plate proximity sensor 64, and thus determines that the display 6 is in the open state with respect to the plate 4. In addition, the processor 11 determines that the plate 4 is in the state of being opened by 90° or less with respect to the imaging apparatus main body 2 by detecting the remote state of the imaging apparatus main body 2 in the back surface direction of the display 6 via the main body proximity sensor 63 and combining the result of the posture detection of the imaging apparatus main body 2 via the main body acceleration sensor 13 and the result of the posture detection of the display 6 via the display acceleration sensor 65.

Based on the determination results, the processor 11 determines that the imaging form of the imaging apparatus 1 is the “horizontal shooting_low-angle form” in which the release button 21 of the imaging apparatus main body 2 is disposed at the upper right, the monitor unit 61 of the display 6 is disposed to face the rear side of the imaging apparatus 1, and the display 6 with the monitor unit 61 facing the rear side is disposed to be opened at an angle of 90° or less (about 30° in the present example) from the rear surface 24 of the imaging apparatus main body 2. The processor 11 performs control of displaying information corresponding to the horizontal shooting_low-angle form on the monitor unit 61 based on the determination result. For example, the processor 11 performs control of normally displaying the information on the monitor unit 61, as in the first form of FIG. 18. In this case, the user can visually recognize the display information of the monitor unit 61 at a low angle on the rear surface side of the imaging apparatus main body 2 while gripping the imaging apparatus main body 2 of the imaging apparatus 1 with the hand, for example.

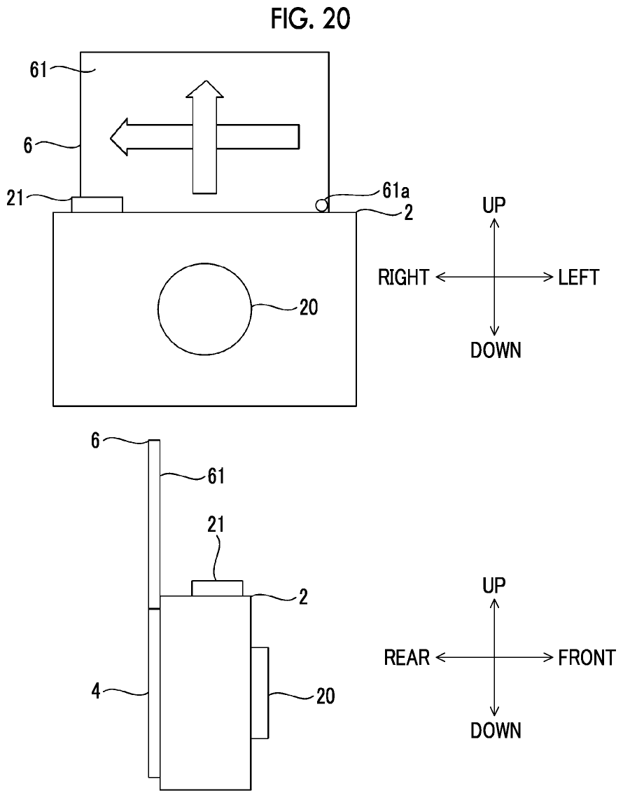

FIG. 20 is a diagram showing a third form of the horizontal shooting in the imaging apparatus 1. In FIG. 20, a front view (upper diagram) of the imaging apparatus 1 as viewed from the lens 20 side of the imaging apparatus main body 2 and a right side view (lower diagram) of the imaging apparatus 1 are shown.

In the case of the third form, the processor 11 detects the posture of the display 6 in the direction of gravitational force via the display acceleration sensor 65 and detects the posture of the imaging apparatus main body 2 in the direction of gravitational force via the main body acceleration sensor 13, and thus determines that the imaging form of the imaging apparatus 1 is the horizontal shooting form in which the release button 21 of the imaging apparatus main body 2 is disposed at the upper right and the display 6 is disposed on the upper side with respect to the imaging apparatus main body 2. In addition, the processor 11 detects the remote state of the plate 4 in the back surface direction of the display 6 via the plate proximity sensor 64 and combines the result of the posture detection of the display 6 via the display acceleration sensor 65 and the result of the posture detection of the imaging apparatus main body 2 via the main body acceleration sensor 13, and thus determines that the display 6 is in a state of being opened by more than 90° with respect to the plate 4. In addition, the processor 11 detects the remote state of the imaging apparatus main body 2 in the back surface direction of the display 6 via the main body proximity sensor 63 and combines the detection result of the remote state of the plate 4 via the plate proximity sensor 64, the result of the posture detection of the display 6 via the display acceleration sensor 65, and the result of the posture detection of the imaging apparatus main body 2 via the main body acceleration sensor 13, and thus determines that the plate 4 is in a closed state with respect to the imaging apparatus main body 2.

Based on these determination results, the processor 11 determines that the imaging form of the imaging apparatus 1 is the “horizontal shooting_upper position form” in which the release button 21 of the imaging apparatus main body 2 is disposed at the upper right, the monitor unit 61 of the display 6 is disposed to face the front of the imaging apparatus 1, and the display 6 with the monitor unit 61 facing the front is disposed to be opened in the upward direction of the imaging apparatus main body 2 at an angle (180° in the present example) more than 90° from the rear surface 24 of the imaging apparatus main body 2.

In the display 6 of FIG. 20 in the horizontal shooting_upper position form, the position of the display origin 61a, which is the upper left end of the monitor unit 61 in FIG. 18, is the position of the lower right end of the monitor unit 61 in FIG. 20. In addition, in the monitor unit 61 in FIG. 20, both the direction of the horizontal arrow and the direction of the vertical arrow of the monitor unit 61 defined in FIG. 18 are opposite to the arrow directions in FIG. 18. Therefore, the processor 11 performs the display control of the monitor unit 61 corresponding to the horizontal shooting_upper position form.

For example, the processor 11 performs the conversion processing of vertically inverting the display state of the monitor unit 61 with respect to the normal display of the horizontal shooting, and displays the converted information on the monitor unit 61. The display state of the monitor unit 61 of the display 6 in this case is referred to as “vertically inverted display” of the horizontal shooting. With the vertically inverted display, even in a case where the display 6 is vertically inverted about the second axis B of the second hinge 41, the information and the like are displayed on the monitor unit 61 of the display 6 such that the user can easily visually recognize the information and the like. In this case, for example, the user can directly visually recognize the display information of the monitor unit 61 on the front surface side of the imaging apparatus main body 2 while gripping the imaging apparatus main body 2 of the imaging apparatus 1 with the hand, and can take a self-portrait.

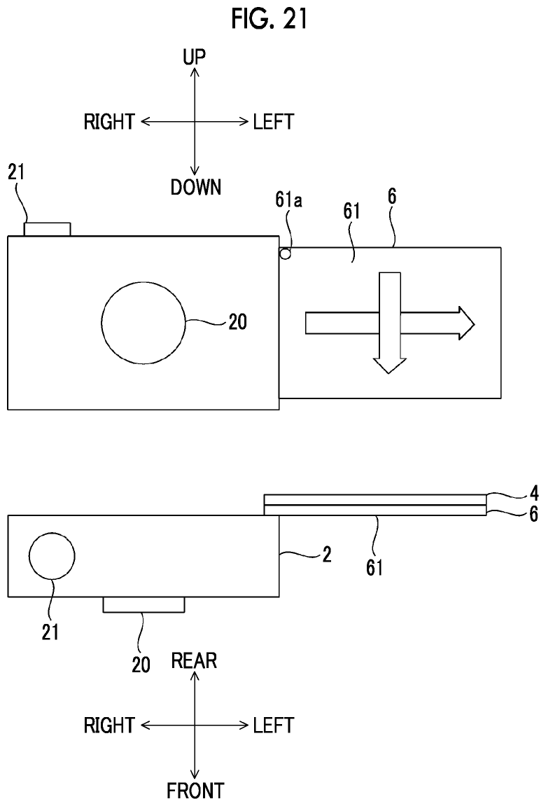

FIG. 21 is a diagram showing a fourth form of the horizontal shooting in the imaging apparatus 1. In FIG. 21, a front view (upper diagram) of the imaging apparatus 1 as viewed from the lens 20 side of the imaging apparatus main body 2 and a top view (lower diagram) of the imaging apparatus 1 are shown.

In the case of the fourth form, the processor 11 detects the posture of the display 6 in the direction of gravitational force by the display acceleration sensor 65 and detects the posture of the imaging apparatus main body 2 in the direction of gravitational force by the main body acceleration sensor 13, and thus, determines that the imaging form of the imaging apparatus 1 is the form of the horizontal shooting in which the release button 21 of the imaging apparatus main body 2 is disposed at the upper right. In addition, the processor 11 detects the proximity state of the plate 4 in the back surface direction of the display 6 by the plate proximity sensor 64, and thus, determines that the display 6 is in a closed state with respect to the plate 4. In addition, the processor 11 detects the remote state of the imaging apparatus main body 2 in the back surface direction of the display 6 by the main body proximity sensor 63, and combines the detection result of the proximity state of the plate 4 by the plate proximity sensor 64, the detection result of the posture of the imaging apparatus main body 2 by the main body acceleration sensor 13, and the detection result of the posture of the display 6 by the display acceleration sensor 65, and thus, determines that the plate 4 is in the open state with respect to the imaging apparatus main body 2.

Based on the determination results, the processor 11 determines that the imaging form of the imaging apparatus 1 is the “horizontal shooting_horizontal position form” in which the release button 21 of the imaging apparatus main body 2 is disposed at the upper right, the monitor unit 61 of the display 6 is disposed to face the front of the imaging apparatus 1, and the display 6 with the monitor unit 61 facing the front is disposed on the left side of the imaging apparatus main body 2. The processor 11 performs control of displaying information corresponding to the horizontal shooting_horizontal position form on the monitor unit 61 based on the determination result. In the display 6 of FIG. 21 in the horizontal shooting_horizontal position form, the position of the display origin 61a in the monitor unit 61 and the orientations of the horizontal arrow and the vertical arrow are the same as the position and the orientations thereof described in FIG. 18. The display state of the monitor unit 61 of the display 6 in this case is referred to as “mirror-inverted display” of the horizontal shooting. In the mirror-inverted display, for example, the user can directly visually recognize the display information of the monitor unit 61 on the front surface side of the imaging apparatus main body 2 while gripping the imaging apparatus main body 2 of the imaging apparatus 1 with the hand, and thus can take a self-portrait.

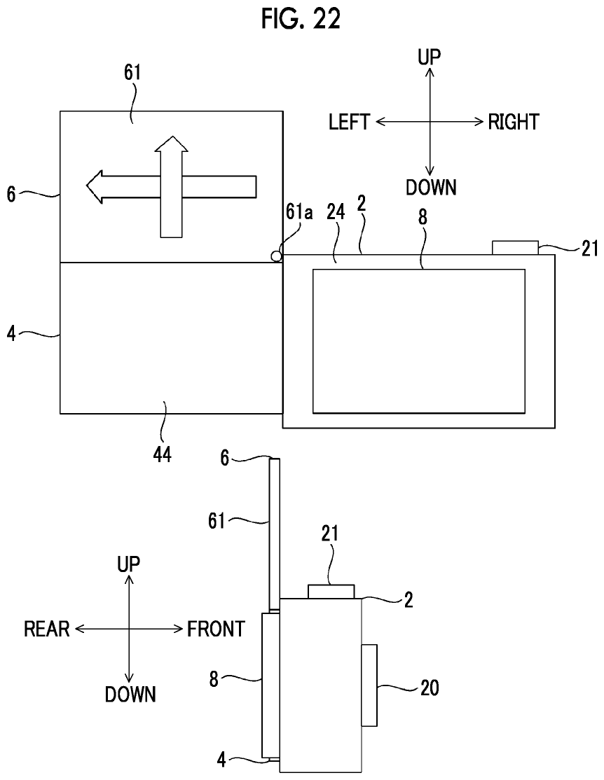

FIG. 22 is a diagram showing a fifth form of the horizontal shooting in the imaging apparatus 1. In FIG. 22, a rear view (upper diagram) of the imaging apparatus 1 as viewed from the rear surface 24 side of the imaging apparatus main body 2 and a right side view (lower diagram) of the imaging apparatus 1 are shown. In the example shown in FIG. 22, the cooling device 8 is attached to the rear surface 24 of the imaging apparatus main body 2.

In the case of the fifth form, the processor 11 detects the posture of the display 6 in the direction of gravitational force by the display acceleration sensor 65 and detects the posture of the imaging apparatus main body 2 in the direction of gravitational force by the main body acceleration sensor 13, and thus, determines that the imaging form of the imaging apparatus 1 is the form of the horizontal shooting in which the release button 21 of the imaging apparatus main body 2 is disposed at the upper right. In addition, the processor 11 detects the remote state of the plate 4 in the back surface direction of the display 6 via the plate proximity sensor 64 and combines the result of the posture detection of the display 6 via the display acceleration sensor 65 and the result of the posture detection of the imaging apparatus main body 2 via the main body acceleration sensor 13, and thus determines that the display 6 is in a state of being opened by more than 90° with respect to the plate 4. In addition, the processor 11 detects the remote state of the imaging apparatus main body 2 in the back surface direction of the display 6 by the main body proximity sensor 63, and combines the detection result of the remote state of the plate 4 by the plate proximity sensor 64, the result of the posture detection of the imaging apparatus main body 2 by the main body acceleration sensor 13, and the result of the posture detection of the display 6 by the display acceleration sensor 65, and thus, determines that the plate 4 is in a state of being opened with respect to the imaging apparatus main body 2. In addition, the processor 11 detects the connection state of the electronic contact of the cooling device 8 with respect to the electronic contact 26 of the imaging apparatus main body 2 by the cooling device communication interface 17, and thus determines that the cooling device 8 is attached to the rear surface 24 of the imaging apparatus main body 2.

Based on the determination results, the processor 11 determines that the imaging form of the imaging apparatus 1 is the “horizontal shooting_cooling device mounting form” in which the release button 21 of the imaging apparatus main body 2 is disposed at the upper right, the plate 4 is in a state of being opened from the imaging apparatus main body 2, the display 6 is opened in the upward direction at an angle (180° in the present example) more than 90°_0 with respect to the plate 4, and the monitor unit 61 of the display 6 is disposed to face the rear side of the imaging apparatus 1.

In the display 6 of FIG. 22 in the horizontal shooting_cooling device mounting form, the position of the display origin 61a, which is the upper left end of the monitor unit 61 in FIG. 18, is the position of the lower right end of the monitor unit 61 in FIG. 22. In addition, in the monitor unit 61 in FIG. 22, both the direction of the horizontal arrow and the direction of the vertical arrow of the monitor unit 61 defined in FIG. 18 are opposite to the arrow directions in FIG. 18. Therefore, the processor 11 performs the display control of the monitor unit 61 corresponding to the horizontal shooting_cooling device mounting form.

For example, the processor 11 performs the conversion processing of vertically inverting the display state of the monitor unit 61 with respect to the normal display of the horizontal shooting, and displays the converted information on the monitor unit 61. The display state of the monitor unit 61 of the display 6 in this case is referred to as “mirror and vertically inverted display” of the horizontal shooting. With the mirror and vertically inverted display, even in a case where the display 6 is vertically inverted about the second axis B of the second hinge 41, the information and the like are displayed on the monitor unit 61 of the display 6 such that the user can easily visually recognize the information and the like. In this case, the user can directly visually recognize the display information of the monitor unit 61 on the rear surface side of the imaging apparatus main body 2 while gripping the imaging apparatus main body 2 of the imaging apparatus 1 on which the cooling device 8 is mounted with the hand, for example, without using a low angle.

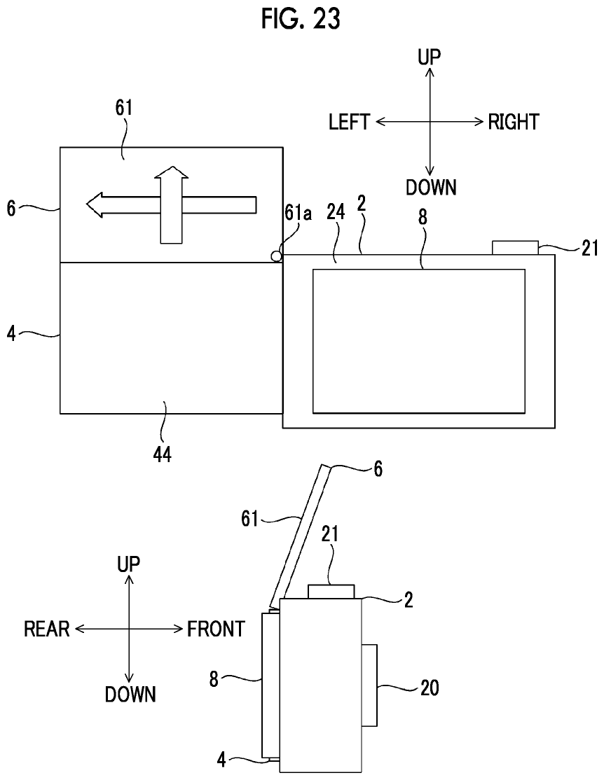

FIG. 23 is a diagram showing a sixth form of the horizontal shooting in the imaging apparatus 1. In FIG. 23, a rear view of the imaging apparatus 1 and a right side view of the imaging apparatus 1 are shown, as in FIG. 22. In addition, the cooling device 8 is attached to the rear surface 24 of the imaging apparatus main body 2.

In the case of the sixth form, the processor 11 determines that the imaging form of the imaging apparatus 1 is the form of the horizontal shooting in which the release button 21 of the imaging apparatus main body 2 is disposed at the upper right, by the posture detection using the display acceleration sensor 65 and the main body acceleration sensor 13, as in the fifth form of FIG. 22. In addition, the processor 11 determines that the display 6 is in a state of being opened by more than 90°with respect to the plate 4 by the detection of the plate proximity sensor 64, the display acceleration sensor 65, and the main body acceleration sensor 13, as in the fifth form. In addition, the processor 11 determines that the plate 4 is in a state of being opened with respect to the imaging apparatus main body 2 by the detection of the main body proximity sensor 63, the plate proximity sensor 64, the main body acceleration sensor 13, and the display acceleration sensor 65, as in the fifth form. In addition, the processor 11 determines that the cooling device 8 is attached to the rear surface 24 of the imaging apparatus main body 2 by the detection of the cooling device communication interface 17, as in the fifth form.

Based on the determination results, the processor 11 determines that the imaging form of the imaging apparatus 1 is the “horizontal shooting_cooling device-mounted low-angle form” in which the release button 21 of the imaging apparatus main body 2 is disposed at the upper right, the plate 4 is in a state of being opened from the imaging apparatus main body 2, the display 6 is opened upward at an angle (about 150° in the present example) more than 90° from the plate 4, and the monitor unit 61 of the display 6 is disposed toward the rear side of the imaging apparatus 1. The processor 11 performs control of displaying information corresponding to the horizontal shooting_cooling device-mounted low-angle form on the monitor unit 61 based on the determination result. For example, the processor 11 performs control of mirror and vertically inverting and displaying the information on the monitor unit 61, as in the fifth form of FIG. 22. In this case, the user can visually recognize the display information of the monitor unit 61 at a low angle on the rear surface side of the imaging apparatus main body 2 while gripping the imaging apparatus main body 2 of the imaging apparatus 1 on which the cooling device 8 is mounted with the hand, for example.

### Disposition Example of Proximity Sensor

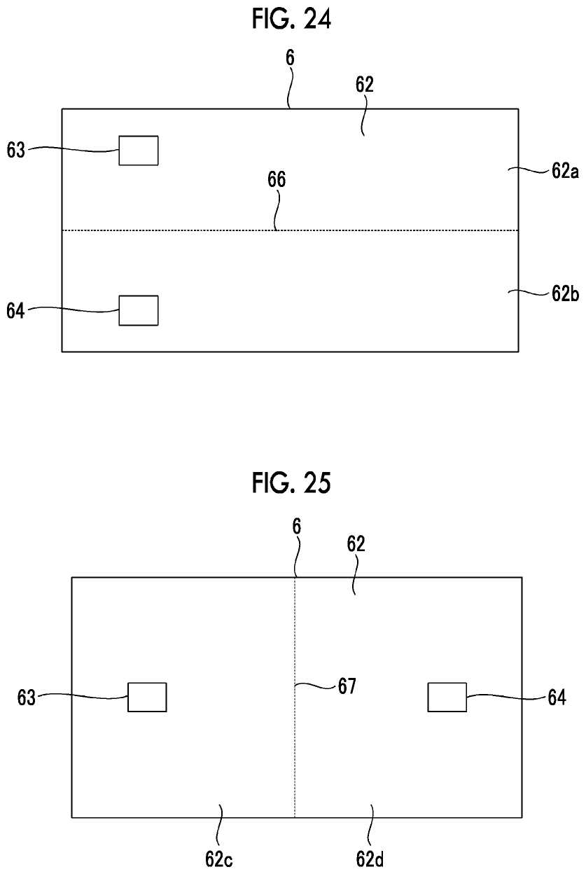

Next, a disposition of the main body proximity sensor 63 and the plate proximity sensor 64 provided in the display 6 will be described with reference to FIGS. 24 and 25.

FIG. 24 is a diagram showing a first form of the disposition of the main body proximity sensor 63 and the plate proximity sensor 64. The first form of the disposition is the same disposition as the disposition of the main body proximity sensor 63 and the plate proximity sensor 64 in the display 6 of the imaging apparatus 1 described above (for example, see FIG. 4). That is, in a case where the display 6 has a substantially rectangular shape as viewed from a direction opposite to the display direction of the monitor unit 61 (direction of the back surface 62 of the display 6), the main body proximity sensor 63 is disposed at an upper left portion of the display 6, and the plate proximity sensor 64 is disposed at a lower left portion of the display 6.

Specifically, in a case where the display 6 is divided into a first region 62a and a second region 62b by a straight line 66 passing through a center portion of the display 6, the main body proximity sensor 63 is provided in the first region 62a, and the plate proximity sensor 64 is provided in the second region 62b. The center portion of the display 6 in the first form is a center portion of the display 6 in a vertical direction shown in FIG. 24.

FIG. 25 is a diagram showing a second form of the disposition of the main body proximity sensor 63 and the plate proximity sensor 64. As shown in FIG. 25, in the second form of the disposition, in a case where the display 6 is divided into a first region 62c and a second region 62d by a straight line 67 passing through a center portion of the display 6, the main body proximity sensor 63 is provided in the first region 62c, and the plate proximity sensor 64 is provided in the second region 62d. The center portion of the display 6 in the second form is a center portion of the display 6 in a horizontal direction shown in FIG. 25.

### Modification Example of Tilt Mechanism

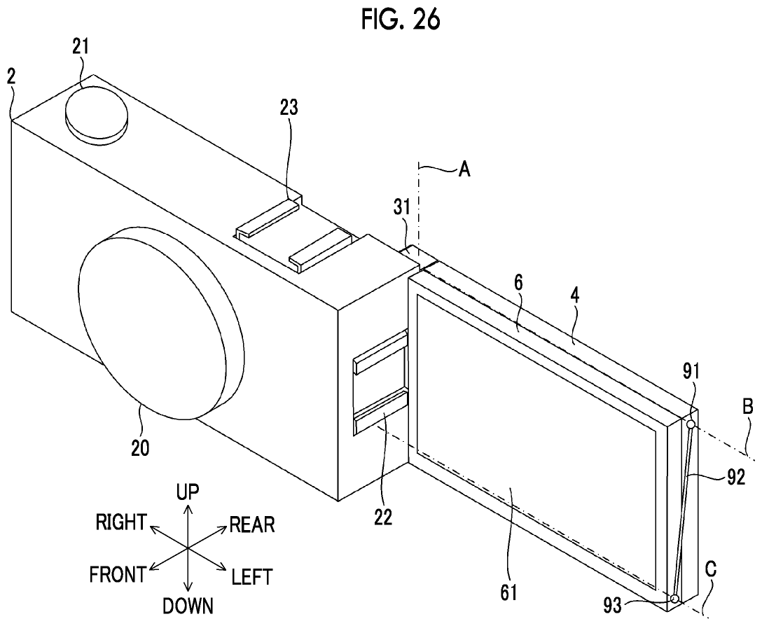

FIG. 26 is a diagram showing a modification example of the tilt mechanism. As shown in FIG. 26, the tilt mechanism of the modification example comprises a first hinge 31 that rotatably connects the imaging apparatus main body 2 and the plate 4 around a first axis A, a second deformation hinge 91 that rotatably connects the arm member 92 and the display 6 around a second axis B, and a third hinge 93 that rotatably connects the plate 4 and the arm member 92 around a third axis C.

The arm member 92 is a member that connects the plate 4 and the display 6. The arm member 92 is composed of two arm members. The arm member 92 is provided along a short side of the plate 4 and the display 6. Although not shown in FIG. 26, another arm member 92 is provided along a short side on a right side of the plate 4 and the display 6. One end portion of the arm member 92 is connected to the plate 4 by the second deformation hinge 91, and the other end portion is connected to the display 6 by the third hinge 93. The arm member 92 is an example of a “fourth component” according to the embodiment of the present invention.

A configuration of the first hinge 31 is the same as the configuration of the first hinge 31 in the above-described embodiment. The second axis B of the second deformation hinge 91 is an axis that extends along a long side on an upper side of the imaging apparatus main body 2. The second axis B is provided in the arm member 92 connected to the plate 4. The third axis C of the third hinge 93 is an axis that extends along a long side on a lower side of the imaging apparatus main body 2. The third axis C is provided in the arm member 92 connected to the display 6. Although not shown, the main body proximity sensor 63, the plate proximity sensor 64, the display acceleration sensor 65, the proximity detection hole 43 of the plate 4, the main body acceleration sensor 13 of the imaging apparatus main body 2, and the like of the display 6 are the same as those of the above-described embodiment.

### Display Control by Imaging Apparatus Comprising Modification Tilt Function

The display control performed by the processor 11 in the imaging form of the imaging apparatus 1 provided with the modification tilt function shown in FIG. 26 will be described below.

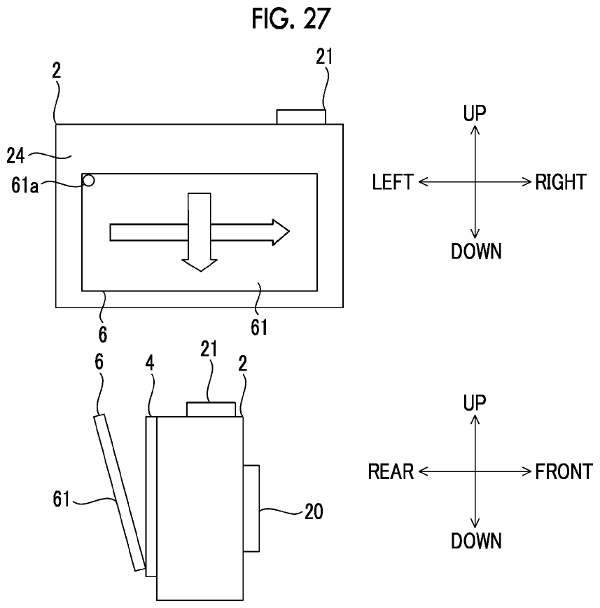

FIG. 27 is a diagram showing an example of the horizontal shooting form in the imaging apparatus 1 provided with the modification tilt function. In FIG. 27, a rear view (upper diagram) of the imaging apparatus 1 as viewed from the rear surface 24 side of the imaging apparatus main body 2 and a right side view (lower diagram) of the imaging apparatus 1 are shown.

In the present example, the processor 11 determines that the imaging form of the imaging apparatus 1 is the form of the horizontal shooting in which the release button 21 is disposed at the upper right by the posture detection of the display 6 by the display acceleration sensor 65 and the posture detection of the imaging apparatus main body 2 by the main body acceleration sensor 13. In addition, the processor 11 detects the remote state of the plate 4 in the back surface direction of the display 6 by the plate proximity sensor 64, and thus determines that the display 6 is in the open state with respect to the plate 4. In addition, the processor 11 determines that the plate 4 is in the state of being opened by 90° or less with respect to the imaging apparatus main body 2 by detecting the remote state of the imaging apparatus main body 2 in the back surface direction of the display 6 via the main body proximity sensor 63 and combining the result of the posture detection of the imaging apparatus main body 2 via the main body acceleration sensor 13 and the result of the posture detection of the display 6 via the display acceleration sensor 65.

Based on the determination results, the processor 11 determines that the imaging form of the imaging apparatus 1 is the “horizontal shooting_high-angle form” in which the release button 21 of the imaging apparatus main body 2 is disposed at the upper right, the monitor unit 61 of the display 6 is disposed to face the rear side of the imaging apparatus 1, and the display 6 with the monitor unit 61 facing the rear side is disposed to be opened at an angle of 90° or less (about 30° in the present example) from the rear surface 24 of the imaging apparatus main body 2 around the third axis C (see FIG. 26) of the third hinge 93. The processor 11 performs control of displaying information corresponding to the horizontal shooting_high-angle form on the monitor unit 61 based on the determination result. For example, the processor 11 performs control of normally displaying the information on the monitor unit 61, as in the first form described with reference to FIG. 18. In this case, the user can visually recognize the display information of the monitor unit 61 at the high angle on the rear surface side of the imaging apparatus main body 2 while gripping the imaging apparatus main body 2 of the imaging apparatus 1 with the hand, for example.

As described above, the imaging apparatus 1 of the present embodiment comprises the tilt mechanism including the first hinge 31 that rotatably connects the imaging apparatus main body 2 and the plate 4 around the first axis A and the second hinge 41 that rotatably connects the plate 4 and the display 6 around the second axis B, and has the recessed portion 34 that exposes the first accessory shoe 22 of the imaging apparatus main body 2 on the rear side of the imaging apparatus main body 2 in a case where the rotational state of the first hinge 31 is the closed state. According to this configuration, the accessory device can be attached to the first accessory shoe 22 provided in the forward direction of the first hinge 31 from the rear side of the imaging apparatus main body 2 via the recessed portion 34 in a case where the first hinge 31 is in the closed state. Accordingly, it is possible to obtain the imaging apparatus 1 having the two-axis configuration while suppressing a decrease in the degree of freedom of attachment of the accessory device to the imaging apparatus main body 2.

In addition, the imaging apparatus 1 has the first accessory shoe 22 on the short side of the imaging apparatus main body 2 and has the second accessory shoe 23 on the long side of the imaging apparatus main body 2. According to this configuration, in a case where the horizontal shooting is performed by the imaging apparatus 1, for example, the stereo microphone as the accessory device can be attached to the second accessory shoe 23 located on the upper side of the imaging apparatus main body 2 in the imaging apparatus 1 shown in FIG. 5, and in a case where the vertical shooting is performed by the imaging apparatus 1, for example, the stereo microphone can be attached to the first accessory shoe 22 located on the upper side of the imaging apparatus main body 2 in the imaging apparatus 1 shown in FIG. 16. Therefore, the two microphones in the stereo microphone attached to the accessory shoe can be attached to be arranged on the left and right sides in both the case of the horizontal shooting and the case of the vertical shooting, and good sound quality can be obtained. In addition, the stereo microphone attached to the accessory shoe can be disposed not to overlap the monitor unit 61 of the display 6 in both the case of the horizontal shooting and the case of the vertical shooting, and thus the stereo microphone does not interfere with the self-portrait.

In addition, the imaging apparatus 1 comprises the main body proximity sensor 63 that detects the proximity to the imaging apparatus main body 2 and the plate proximity sensor 64 that detects the proximity to the plate 4 in the imaging apparatus main body 2. For example, in a case where these sensors are provided in the plate 4, the sensors are suitable for determining the opening and closing of the first hinge 31 and the second hinge 41, but it is necessary to provide the proximity sensors on both surfaces of the plate 4, which leads to an increase in cost and an increase in the size of the apparatus. In addition, in a case where these sensors are provided in the imaging apparatus main body 2, the cooling device 8 interferes with the determination by the sensors in a case where the cooling device 8 is attached to the imaging apparatus main body 2. On the other hand, by providing the two proximity sensors in the imaging apparatus main body 2, it is possible to avoid these problems.

In addition, the imaging apparatus 1 can attach the cooling device 8 to the imaging apparatus main body 2 in a case where the rotational state of the first hinge 31 in the imaging apparatus main body 2 is the open state. For example, in a case where the imaging apparatus 1 has a single-axis configuration as in the related art, the cooling device 8 interferes with the display 6 in a case where the cooling device 8 is attached to the rear surface of the imaging apparatus main body 2, and thus the display direction of the monitor unit 61 in the display 6 cannot be rotated to be parallel to the rear surface of the imaging apparatus main body 2, and the imaging is performed in a form of the self-portrait (the imaging direction and the display direction match) or the low angle (the display 6 is in a state of being opened by about 90°). On the other hand, by adopting the two-axis configuration as in the present invention, for example, as shown in FIGS. 10 and 17, it is possible to perform imaging in normal imaging in which the imaging direction and the display direction are opposite to each other even in the horizontal shooting form and the vertical shooting form.

In addition, in the imaging apparatus 1, the imaging apparatus main body 2 and the plate 4 are connected by the first hinge 31, and the plate 4 and the display 6 are connected by the second hinge 41. Therefore, the signal wiring is not twisted between the imaging apparatus main body 2 and the plate 4 and between the plate 4 and the display 6. Therefore, the FPC 9 can be adopted as the signal wiring that electrically connects the imaging apparatus main body 2 and the display 6. Accordingly, it is not necessary to use the thin coaxial cable for connecting the imaging apparatus main body 2 and the display 6, and thus it is possible to reduce the cost. In addition, the FPC 9 need only be bent between the imaging apparatus main body 2 and the plate 4 and between the plate 4 and the display 6, and it is not necessary to complexly fold the FPC 9 to deal with the twisting. Therefore, it is possible to reduce the size of the imaging apparatus 1.

Various embodiments are described above, but it goes without saying that the present invention is not limited to such examples. It is apparent that those skilled in the art may perceive various modification examples or correction examples within the scope disclosed in the claims, and those examples are also understood as falling within the technical scope of the present invention. Each constituent in the above embodiment may be adopted in any combination without departing from the gist of the invention.

The present application is based on Japanese Patent Application (JP2023-218070) filed on Dec. 25, 2023, the content of which is incorporated in the present application by reference.

### EXPLANATION OF REFERENCES

1: imaging apparatus
2: imaging apparatus main body
4: plate
6: display
8: cooling device
9: FPC
11: processor
12: memory
13: main body acceleration sensor
14: imaging unit
15: accessory communication interface
16: display communication interface
17: cooling device communication interface
18: bus
20: lens
21: release button
22: first accessory shoe
23: second accessory shoe
24: rear surface
25a, 25b: screw hole
26: electronic contact
31: first hinge
32a: first fixing part
32b: second fixing part
33: rotating portion
34: recessed portion
41: second hinge
42, 44: surface
43: proximity detection hole
61: monitor unit
61a: display origin
62: back surface
62a, 62c: first region
62b, 62d: second region
63: main body proximity sensor
64: plate proximity sensor
65: display acceleration sensor
66, 67: straight line
81a, 81b: screw
91: second deformation hinge
92: arm member
93: third hinge

What is claimed is:

1. A tilt mechanism of an imaging apparatus, the imaging apparatus including a first component including an imaging unit, a second component, a third component including a monitor unit, and a fourth component, the tilt mechanism comprising:
a first hinge that rotatably connects the first component and the second component around a first axis and allows the first component and the second component to be opened and closed;
a second hinge that rotatably connects the second component and the third component around a second axis and allows the second component and the third component to be opened and closed; and
a third hinge that rotatably connects the second component and the fourth component around a third axis,
wherein the first component includes a first attachment portion to which an accessory device is attachable,
the first hinge includes a recessed portion that exposes the first attachment portion on a side in a predetermined direction in a case where a rotational state of the first hinge is a first state, and
the second hinge rotatably connects the fourth component and the third component around the second axis.

2. The tilt mechanism according to claim 1,
wherein the first attachment portion is provided on a side in a first direction of a portion of the first component where the first hinge is provided, and the accessory device is attachable by insertion from a second direction opposite to the first direction, and
the predetermined direction is the second direction.

3. The tilt mechanism according to claim 1,
wherein at least a part of the first attachment portion is disposed so as to extend into the first component, and
in the first state,
the first attachment portion is
only partially visible as viewed from a first direction of the first component, and
entirely visible as viewed from a second direction opposite to the first direction.

4. The tilt mechanism according to claim 1,
wherein the first state is a rotational state of the first hinge in which the second component is closed with respect to the first component.

5. The tilt mechanism according to claim 1,
wherein the imaging apparatus includes a flexible electronic substrate that electrically connects the first component and the third component.

6. An imaging apparatus including the tilt mechanism according to claim 1,
wherein a cooling device that cools the first component is attachable to the first component in a case where the rotational state of the first hinge is a second state.

7. A tilt mechanism of an imaging apparatus, the imaging apparatus including a first component including an imaging unit, a second component, and a third component including a monitor unit, the tilt mechanism comprising:
a first hinge that rotatably connects the first component and the second component around a first axis and allows the first component and the second component to be opened and closed; and
a second hinge that rotatably connects the second component and the third component around a second axis and allows the second component and the third component to be opened and closed;
wherein the first component includes a first attachment portion to which an accessory device is attachable, and further includes, at a position different from a position of the first attachment portion, a second attachment portion to which the accessory device is attachable in an attachment direction different from an attachment direction of the first attachment portion, and
the first hinge includes a recessed portion that exposes the first attachment portion on a side in a predetermined direction in a case where a rotational state of the first hinge is a first state.

8. An imaging apparatus comprising a first component including an imaging unit, a second component, a third component including a monitor unit, and a tilt mechanism, the tilt mechanism comprising:
a first hinge that rotatably connects the first component and the second component around a first axis and allows the first component and the second component to be opened and closed; and
a second hinge that rotatably connects the second component and the third component around a second axis and allows the second component and the third component to be opened and closed;
wherein the first component includes a first attachment portion to which an accessory device is attachable,
the first hinge includes a recessed portion that exposes the first attachment portion on a side in a predetermined direction in a case where a rotational state of the first hinge is a first state,
the third component includes a first acceleration sensor, a first proximity sensor that detects proximity to the first component, and a second proximity sensor that detects proximity to the second component, and
the imaging apparatus comprises a control unit that performs control of display on the monitor unit, based on detection results of the first acceleration sensor, the first proximity sensor, and the second proximity sensor.

9. The imaging apparatus according to claim 8,
wherein the imaging apparatus is configured such that a predetermined device is attachable in a case where the rotational state of the first hinge is a second state,
the imaging apparatus further comprises an attachment sensor that detects presence or absence of attachment of the predetermined device, and
the control unit performs the control of the display based on detection results of the first acceleration sensor, the first proximity sensor, the second proximity sensor, and the attachment sensor.

10. The imaging apparatus according to claim 9,
wherein the second state is a rotational state of the first hinge in which the second component is opened with respect to the first component.

11. The imaging apparatus according to claim 9,
wherein the first component includes a second acceleration sensor, and
the control unit performs the control of the display based on detection results of the first acceleration sensor, the first proximity sensor, the second proximity sensor, the attachment sensor, and the second acceleration sensor.

12. The imaging apparatus according to claim 8,
wherein the first proximity sensor detects proximity of the first component in a third direction of the third component,
the second proximity sensor detects proximity of the second component in the third direction of the third component, and
in a case where the third component is divided into a first region and a second region by a straight line passing through a center portion of the third component as viewed from the third direction, the first proximity sensor is provided in the first region, and the second proximity sensor is provided in the second region.
